(19) United States
(12) Patent Application Publication
(10) Pub. No.: US 2009/0155645 A1
(43) Pub. Date: Jun. 18, 2009

(54) SYSTEM AND PROCESS FOR GENERATING ELECTRICAL POWER

(76) Inventors: Jingyu CUI, Katy, TX (US); Erik Edwin Engwall, Houston, TX (US); Mahendra Ladharam Joshi, Katy, TX (US); Scott Lee Wellington, Bellaire, TX (US)

Correspondence Address: SHELL OIL COMPANY, P O BOX 2463, HOUSTON, TX, 772522463, US

(21) Appl. No.: 12/335,392

(22) Filed: Dec. 15, 2008

Related U.S. Application Data
(60) Provisional application No. 61/014,277, filed on Dec. 17, 2007.

(51) Int. Cl. H01M 8/04

(52) U.S. Cl. 429/17

(57) ABSTRACT

The present invention is directed to a process for generating electricity in a solid oxide fuel cell system. A mixture of steam and a hydrocarbon containing feed is reformed to produce a reformed product gas containing hydrogen. A first gas stream containing at least 0.6 mole fraction hydrogen is separated from the reformed product gas and fed to the anode of a solid oxide fuel cell. The first gas stream is mixed with an oxidant at one or more anode electrodes in the fuel cell to generate electricity. An anode exhaust stream comprising hydrogen and water is separated from the fuel cell. The anode exhaust stream and/or a cathode exhaust stream from the fuel cell is fed into the reforming reactor, where heat is exchanged between the hot anode and/or cathode exhaust streams and the reactants in the reforming reactor.

This application claims the benefit of U.S. Provisional Application No. 61/014,277, filed Dec. 17, 2007, which is incorporated herein by reference.

### FIELD OF THE INVENTION

The present invention relates to electrical power generating fuel cell systems, and to a process for generating electrical power. In particular, the present invention relates to an electrical power generating solid oxide fuel cell system and a process for generating electrical power with such a system.

### BACKGROUND OF THE INVENTION

Solid oxide fuel cells are fuel cells that are composed of solid state elements that generate electrical power directly from an electrochemical reaction. Such fuel cells are useful in that they deliver high quality reliable electrical power, are clean operating, and are relatively compact power generators-making their use attractive in urban areas.

Solid oxide fuel cells are formed of an anode, a cathode, and a solid electrolyte sandwiched between the anode and cathode. An oxidizable fuel gas, or a gas that may be reformed in the fuel cell to an oxidizable fuel gas, is fed to the anode, and an oxygen containing gas, typically air, is fed to the cathode to provide the chemical reactants. The oxidizable fuel gas fed to the anode is typically syngas—a mixture of hydrogen and carbon monoxide. The fuel cell is operated at a high temperature, typically from 800° C. to 1100° C., to convert oxygen in the oxygen containing gas to ionic oxygen that may cross the electrolyte to interact with hydrogen and/or carbon monoxide from the fuel gas at the anode. Electrical power is generated by the conversion of oxygen to ionic oxygen at the cathode and the chemical reaction of the ionic oxygen with hydrogen and/or carbon monoxide at the anode. The following reactions describe the electrical power generating chemical reactions in the cell:

Cathode charge transfer: O₂+4e⁻→2O⁻

Anode charge transfer: H₂+O⁻→H₂O+2e⁻ and

CO+O⁻→CO₂+2e⁻

An electrical load or storage device may be connected between the anode and the cathode so an electrical current may flow between the anode and cathode, powering the electrical load or providing electrical power to the storage device.

Fuel gas is typically supplied to the anode by a steam reforming reactor that reforms a low molecular weight hydrocarbon and steam into hydrogen and carbon oxides. Methane, for example as natural gas, is a preferred low molecular weight hydrocarbon used to produce fuel gas for the fuel cell. Alternatively, the fuel cell anode may be designed to internally effect a steam reforming reaction on a low molecular weight hydrocarbon such as methane and steam supplied to the anode of the fuel cell.

Methane steam reforming provides a fuel gas containing hydrogen and carbon monoxide according to the following reaction: CH₄+H₂O⇄CO+3H₂. Heat must be supplied to effect the steam reforming reaction since the reaction to form hydrogen and carbon monoxide is quite endothermic. The reaction is typically conducted at a temperature in the range of 750° C. to 1100° C. to convert a substantial amount of methane or other hydrocarbon and steam to hydrogen and carbon monoxide.

Heat for inducing the methane steam reforming reaction in a steam reforming reactor has been conventionally provided by a burner that combusts an oxygen containing gas with a fuel, typically a hydrocarbon fuel such as natural gas, to provide the required heat. Flameless combustion has also been utilized to provide the heat for driving the steam reforming reaction, where the flameless combustion is also driven by providing a hydrocarbon fuel and a oxygen containing gas to a flameless combustor in relative amounts that avoid inducing flammable combustion. These methods for providing the heat necessary to drive a steam reforming reaction are relatively inefficient energetically since a significant amount of thermal energy provided by combustion is not captured and is lost.

U.S. Pat. No. 4,128,700 discloses a system and a process thermally integrating a steam reforming reactor and a fuel cell, where the fuel cell provides heat to drive the reforming reactor and the reforming reactor provides a fuel gas for the fuel cell. The steam reforming reactor is heated by burning exhaust from a fuel cell anode, mostly unreacted hydrogen and water, to drive the reforming reaction and to produce reformed products including hydrogen and carbon monoxide. The reformed products are fed to the fuel cell for electrochemical reaction in the fuel cell. The hot burner gases formed by burning the fuel cell anode exhaust are of sufficiently high temperature to provide the heat to drive the 750° C.-1100° C. steam reforming reaction in the reforming reactor. The system thermally integrates the operation of the reforming reactor and the fuel cell, however, the thermal integration is relatively inefficient since 1) a great deal of thermal energy provided by burning the fuel cell exhaust is not captured and is lost; and 2) hydrogen is a very expensive fuel for use to drive a burner.

U.S. Patent Application No. 2005/0164051 discloses a system and a process in which a reforming reactor may be thermally integrated with a fuel cell, where heat produced by the fuel cell is used to provide heat to drive the endothermic reaction of the reforming reactor. The reforming reactor is thermally integrated with the fuel cell by placing the reforming reactor in the same hot box as the fuel cell and/or by placing the fuel cell and the reformer in thermal contact with each other. The fuel cell and the reformer may be placed in thermal contact with each other by placing the reformer in close proximity to the fuel cell, where the cathode exhaust conduit of the fuel cell may be in direct contact with the reformer (e.g. by wrapping the cathode exhaust conduit around the reformer, or by one or more walls of the reformer comprising a wall of the cathode exhaust conduit) so that the cathode exhaust from the fuel cell provides conductive heat transfer to the reformer. Supplemental heat is provided from a combustor to the reformer, where the thermal contact of the fuel cell and the reformer lowers the combustion heat requirement of the reformer to effect the reforming reaction (see, e.g., paragraph 0085 of the application). While more efficient than capture of thermal energy from combustion, the process is still relatively inefficient since 1) the heat from the fuel cell is insufficient to completely drive the reforming reaction since the heat of the exhaust from the fuel cell has a temperature at or near the temperature required to drive the reforming reaction (750° C.-1100° C.), and, unless near perfect heat exchange occurs, the heat from the fuel cell will not be sufficient to drive the reforming reaction without additional heat from another source such as a combustor; and 2) significant amounts of heat from the fuel cell exhaust will be convectively transferred away from the reforming reactor as well as towards the reactor.

Furthermore, solid oxide fuel cells coupled with reforming reactors are typically run in a manner that is not electrochemically efficient and does not produce a high electrical power density. Solid oxide fuel cells are typically operated commercially in a “hydrogen-lean” mode, where the conditions of the production of the fuel gas, for example by steam reforming, are selected to limit the amount of hydrogen exiting the fuel cell in the fuel gas. This is done to balance the electrical energy potential of the hydrogen in the fuel gas with the potential energy (thermal+electrochemical) lost by hydrogen leaving the cell without being converted to electrical energy.

Fuel gases containing non-hydrogen compounds, such as carbon monoxide or carbon dioxide, however, are less efficient for producing electrical power in a solid oxide fuel cell than more pure hydrogen fuel gas streams. At a given temperature the electrical power that may be generated in a solid oxide fuel cell increases with increasing hydrogen concentration. This is due to the electrochemical oxidation potential of molecular hydrogen relative to other compounds. For example, molecular hydrogen can produce an electrical power density of 1.3 W/cm² at 0.7 volts while carbon monoxide can produce an electrical power density of only 0.5 W/cm² at 0.7 volts. Therefore, fuel gas streams containing significant amounts of non-hydrogen compounds are not as efficient in producing electrical power in a solid oxide fuel cell as fuel gases containing mostly hydrogen.

Certain measures have been taken to recapture the energy of excess hydrogen exiting the fuel cell, however, these are significantly less energy efficient than if the hydrogen were electrochemically reacted in the fuel cell. For example, the anode exhaust produced by reacting the fuel gas electrochemically in the fuel cell has been combusted to drive a turbine expander to produce electricity. This, however, is significantly less efficient than capturing the electrochemical potential of the hydrogen in the fuel cell since much of the thermal energy is lost rather than converted by the expander to electrical energy. Fuel gas exiting the fuel cell also has been combusted to provide thermal energy for a variety of heat exchange applications, including driving the reforming reactor as noted above. Almost 50% of the thermal energy provided by combustion, however, is not captured and is lost. Hydrogen is a very expensive gas to use to fire a burner, therefore, conventionally, the amount of hydrogen used in the solid oxide fuel cell is adjusted to utilize most of the hydrogen provided to the fuel cell to produce electrical power and minimize the amount of hydrogen exiting the fuel cell in the fuel cell exhaust.

U.S. Patent Application Publication No. 2007/0017369 (the '369 publication) provides a method of operating a fuel cell system in which a feed is provided to a fuel inlet of the fuel cell. The feed may include a mixture of hydrogen and carbon monoxide provided from an external steam reformer or, alternatively may include a hydrocarbon feed that is reformed to hydrogen and carbon monoxide internally in the fuel cell stack. The fuel cell stack is operated to generate electricity and a fuel exhaust stream that contains hydrogen and carbon monoxide, where the hydrogen and carbon monoxide in the fuel exhaust stream are separated from the fuel exhaust stream and fed back to the fuel inlet as a portion of the feed. The fuel gas for the fuel cell, therefore, is a mixture of hydrogen and carbon monoxide derived by reforming a hydrocarbon fuel source and hydrogen and carbon monoxide separated from the fuel exhaust system. Recycling at least a portion of the hydrogen from the fuel exhaust through the fuel cell enables a high operation efficiency to be achieved. The system further provides high fuel utilization in the fuel cell by utilizing about 75% of the fuel during each pass through the stack.

U.S. Patent Application Publication No. 2005/0164051 provides a method of operating a fuel cell system in which a fuel is provided to a fuel inlet of the fuel cell. The fuel may be a hydrocarbon fuel such as methane; natural gas containing methane with hydrogen and other gases; propane; biogas; an unreformed hydrocarbon fuel mixed with a hydrogen fuel from a reformer; or a mixture of a non-hydrocarbon carbon containing gas such as carbon monoxide, carbon dioxide, oxygenated carbon containing gas such as methanol, or other carbon containing gas with a hydrogen containing gas such as water vapor or syngas. The fuel cell stack is operated to generate electricity and a fuel exhaust stream that contains hydrogen. A hydrogen separator is utilized to separate non-utilized hydrogen from the fuel side exhaust stream of the fuel cell. The hydrogen separated by the hydrogen separator may be re-circulated back to the fuel cell or may be directed to a subsystem for other uses having a hydrogen demand. The amount of hydrogen re-circulated back to the fuel cell may be selected according to electrical demand or hydrogen demand, where more hydrogen is re-circulated back to the fuel cell when electrical demand is high. The fuel cell stack may be operated at a fuel utilization rate of from 0 to 100%, depending on electrical demand. When the electrical demand is high, the fuel cell is operated at a high fuel utilization rate to increase electricity production—a preferred rate is from 50 to 80%.

Further improvement in the thermal efficiency and electrical efficiency to increase electrical power density in reforming reactor-solid oxide fuel cell systems and processes for operating such systems is desirable.

### SUMMARY OF THE INVENTION

In one aspect, the present invention is directed to a process for generating electricity, comprising:

in a reforming reactor, contacting a mixture of steam and a feed containing one or more gaseous hydrocarbons with a reforming catalyst at a temperature of at least 400° C. to produce a reformed product gas containing hydrogen and at least one carbon oxide;

separating a first gas stream containing at least 0.6, or at least 0.7, or at least 0.8, or at least 0.9, or at least 0.95 mole fraction hydrogen from the reformed product gas;

feeding the first gas stream to an anode of a solid oxide fuel cell;

mixing the first gas stream with an oxidant at one or more anode electrodes in the anode of the solid oxide fuel cell to generate electricity at an electrical power density of at least 0.4 W/cm²;

separating an anode exhaust stream comprising hydrogen and water from the solid oxide fuel cell; and

within the reforming reactor, exchanging heat between the mixture of steam and feed and a heat source selected from the group consisting of the anode exhaust stream, a cathode exhaust stream separated from the fuel cell, and both the anode exhaust stream and the cathode exhaust stream.

In another aspect the present invention is directed to a process for generating electricity, comprising:

in a pre-reforming reactor, contacting a mixture of steam and a feed precursor, the feed precursor containing a vaporizable hydrocarbon that is liquid at 20° C. at atmospheric pressure and that is vaporizable at temperatures up to 400° C. at atmospheric pressure, with a pre-reforming catalyst at a temperature of at least 600° C. to produce a feed comprising one or more gaseous hydrocarbons;

in a reforming reactor, contacting a mixture of the feed and steam with a reforming catalyst at a temperature of at least 400° C. to produce a reformed product gas containing hydrogen and at least one carbon oxide;

separating a first gas stream containing at least 0.6, or at least 0.7, or at least 0.8, or at least 0.9, or at least 0.95 mole fraction hydrogen from the reformed product gas;

feeding the first gas stream to an anode of a solid oxide fuel cell;

mixing the first gas stream with an oxidant at one or more anode electrodes in the anode of the solid oxide fuel cell to generate electricity at an electrical power density of at least 0.4 W/cm²; and

separating an anode exhaust stream comprising hydrogen and water from the solid oxide fuel cell; and

within the pre-reforming reactor, exchanging heat between the mixture of steam and feed precursor and a heat source selected from the group consisting of the anode exhaust stream, a cathode exhaust stream separated from the fuel cell, and both the anode exhaust stream and the cathode exhaust stream.

### BRIEF DESCRIPTION OF THE DRAWINGS

FIG. 1 is a schematic of a system for conducting a process of the present invention in which a reforming reactor is operatively connected to and thermally integrated with a solid oxide fuel cell.

FIG. 2 is a schematic of a system for conducting a process of the present invention in which a pre-reforming reactor and a reforming reactor are operatively connected to and thermally integrated with a solid oxide fuel cell.

FIG. 3 is a schematic of a part of a system for conducting a process of the present invention in which a hydrogen separation device is operatively connected to a reforming reactor.

FIG. 4 is a schematic drawing of a basic system for producing electricity in accordance with a process of the present invention.

FIG. 5 is a schematic drawing of a basic system for producing electricity in accordance with a process of the present invention in which a hydrogen separation apparatus is located exterior of a reforming reactor.

### DETAILED DESCRIPTION OF THE INVENTION

The present invention provides a highly efficient system and process for generating electricity at a high electrical power density in a system utilizing a solid oxide fuel cell. First, the system and process of the present invention are more thermally energetically efficient than processes disclosed in the art, transferring thermal energy from a fuel cell exhaust directly into a reforming reactor, where the reforming reactor is designed to produce hydrogen at much lower temperatures than typical reforming reactors so the heat from the anode exhaust of the fuel cell is sufficiently hot enough to drive the lower temperature reforming reactions with no extraneous heat source. Second, the process of the present invention produces a higher electrical power density in a solid oxide fuel cell system than processes disclosed in the art by utilizing a hydrogen-rich fuel and minimizing rather than maximizing the per pass fuel utilization rate of the fuel cell, which is achieved by separating and recycling hydrogen captured from the fuel exhaust of the fuel cell and feeding the hydrogen from a feed and the recycle stream at selected rates to minimize the per pass fuel utilization rate.

In the process of the present invention, heat from the anode exhaust of the fuel cell and, optionally, the cathode exhaust, is directed into the reforming reactor through an anode exhaust conduit and, optionally, through a cathode exhaust conduit, respectively, located within the reforming reactor. Heat from the anode exhaust and, optionally, the cathode exhaust, may be transferred by heat exchange to hydrocarbon and steam reactants, and the reforming catalyst, within the reforming reactor to drive the reaction of the reactants to produce hydrogen. Transfer of the heat from the exhaust streams from the fuel cell to the reforming reactor within the reforming reactor permits efficient heat exchange with little loss of thermal energy outside the reactor.

In the process of the invention, the reforming reactions may be effected at a lower temperature than typical reforming reactions since hydrogen is removed from the reaction products, driving the reforming equilibrium towards the formation of hydrogen and permitting the reforming reaction temperature to be lowered. As a result, the temperature of the fuel cell exhaust(s) exchanging heat with the reformer reactants is significantly higher than the temperature required to effect the reforming reaction, so the heat provided by the fuel cell exhaust(s) is sufficient to drive the reforming reactions without any additional heat source. Further, more hydrogen may be produced at the lower reforming reactor temperatures since the equilibrium of the water-gas shift reaction H₂O+CO⇄CO₂+H₂ favors the production of hydrogen at the lower reforming reactor temperatures, whereas it is not favored at conventional reforming reaction temperatures.

In the process of the present invention the anode of a solid oxide fuel cell is flooded with hydrogen over the entire path length of the anode so that the concentration of hydrogen at the anode electrode available for electrochemical reaction is maintained at a high level over the entire anode path length, thereby maximizing the electrical power density of the fuel cell. Use of a hydrogen-rich fuel that is primarily, and preferably almost all, hydrogen in the process maximizes the electrical power density of the fuel cell system since hydrogen has a significantly greater electrochemical potential than other oxidizable compounds typically used in solid oxide fuel cell systems such as carbon monoxide.

The process of the present invention also maximizes the electrical power density of the fuel cell system by minimizing, rather than maximizing, the per pass fuel utilization rate of the fuel in the solid oxide fuel cell. The per pass fuel utilization rate is minimized to reduce the concentration of oxidation products, particularly water, throughout the anode path length of the fuel cell so that a high hydrogen concentration is maintained throughout the anode path length. A high electrical power density is provided by the fuel cell since an excess of hydrogen is present for electrochemical reaction at the anode electrode along the entire anode path length of the fuel cell. In a process directed to achieving a high per pass fuel utilization rate, for example greater than 60% fuel utilization, the concentration of oxidation products may comprise greater than 30% of the fuel stream before the fuel has traveled even halfway through the fuel cell, and may be several multiples of the concentration of hydrogen in the fuel cell exhaust so that the electrical power provided along the anode path may significantly decrease as the fuel provided to the fuel cell progresses through the anode.

The process of the present invention is also highly efficient since hydrogen not utilized to produce electricity in the fuel cell is separated from the anode exhaust of the fuel cell and recycled continuously back to the fuel cell. This enables production of a high electrical power density relative to the lowest heating value of the fuel by eliminating the problem associated with losing thermal energy by hydrogen leaving the cell without being converted to electrical energy.

In the system of the present invention, an anode exhaust conduit and/or a cathode exhaust conduit are located in a reforming reactor, and through which heat may be transferred to the reforming reactor to drive reforming reactions in the reactor. An anode exhaust conduit may be coupled to an anode exhaust of the fuel cell so that hot anode exhaust gases from the fuel cell may be directed through the anode exhaust conduit in the reforming reactor to provide thermal energy to drive the reforming reactions in the reforming reactor. Likewise, a cathode exhaust conduit may be coupled to a cathode exhaust of the fuel cell so that hot cathode exhaust gases from the fuel cell may be directed through the cathode exhaust conduit in the reforming reactor to drive the reforming reactions in the reforming reactor.

In the system of the present invention, a hydrogen separation apparatus may separate hydrogen from reformed product gases produced by the reforming reactor. The hydrogen separation apparatus is coupled to the anode inlet of the fuel cell so that a hydrogen rich fuel may be provided to the fuel cell. The anode exhaust may be recycled back to the anode inlet to provide further hydrogen so the system is very electrochemically efficient.

As used herein, the term “hydrogen” refers to molecular hydrogen unless specified otherwise.

As used herein, the “amount of water formed in the fuel cell per unit time of measurement” is calculated as follows: Amount of Water Formed in Fuel Cell per Unit Time of Measurement=[Amount of Water Measured Exiting the Fuel Cell in the Anode Exhaust of the Fuel Cell Per Unit of Time of Measurement]−[Amount of Water Present in the Fuel Fed to the Anode of the Fuel Cell Per Unit of Time of Measurement]. For example, if measurements of the amount of water in a fuel fed to the anode of a fuel cell and exiting the fuel cell in the anode exhaust are taken for 2 minutes, where the measured amount of water in the fuel fed to the anode is 6 moles and the measured amount of water exiting the fuel cell in the anode exhaust is 24 moles, the amount of water formed in the fuel cell as calculated herein is (24 moles/2 minutes)−(6 moles/2 minutes)=12 moles/min−3 moles/min=9 moles/min.

As used herein, when two or more elements are described as “operatively connected” or “operatively coupled”, the elements are defined to be directly or indirectly connected to allow direct or indirect fluid flow between the elements. The term “fluid flow”, as used herein, refers to the flow of a gas or a fluid. When two or more elements are described as “selectively operatively connected” or “selectively operatively coupled”, the elements are defined to be directly or indirectly connected or coupled to allow direct or indirect fluid flow of a selected gas or fluid between the elements. As used in the definition of “operatively connected” or “operatively coupled” the term “indirect fluid flow” means that the flow of a fluid or a gas between two defined elements may be directed through one or more additional elements to change one or more aspects of the fluid or gas as the fluid or gas flows between the two defined elements. Aspects of a fluid or a gas that may be changed in indirect fluid flow include physical characteristics, such as the temperature or the pressure of a gas or a fluid, and/or the composition of the gas or fluid, e.g. by separating a component of the gas or fluid, for example, by condensing water from a gas stream containing steam. “Indirect fluid flow”, as defined herein, excludes changing the composition of the gas or fluid between the two defined elements by chemical reaction, for example, oxidation or reduction of one or more elements of the fluid or gas.

As used herein, the term “selectively permeable to hydrogen” is defined as permeable to molecular hydrogen or elemental hydrogen and impermeable to other elements or compounds such that at most 10%, or at most 5%, or at most 1% of the non-hydrogen elements or compounds may permeate what is permeable to the molecular or elemental hydrogen.

As used herein, the term “high temperature hydrogen-separation device” is defined as a device or apparatus effective for separating hydrogen, in molecular or elemental form, from a gas stream at a temperature of at least 250° C., typically at temperatures of from 300° C. to 650° C.

As used herein, “per pass hydrogen utilization” as referring to the utilization of hydrogen in a fuel in a solid oxide fuel cell, is defined as the amount of hydrogen in a fuel utilized to generate electricity in one pass through the solid oxide fuel cell relative to the total amount of hydrogen in a fuel input into the fuel cell for that pass. The per pass hydrogen utilization may be calculated by measuring the amount of hydrogen in a fuel fed to the anode of a fuel cell, measuring the amount of hydrogen in the anode exhaust of the fuel cell, subtracting the measured amount of hydrogen in the anode exhaust of the fuel cell from the measured amount of hydrogen in the fuel fed to the fuel cell to determine the amount of hydrogen used in the fuel cell, and dividing the calculated amount of hydrogen used in the fuel cell by the measured amount of hydrogen in the fuel fed to the fuel cell. The per pass hydrogen utilization may be expressed as a percent by multiplying the calculated per pass hydrogen utilization by 100.

As used herein, the term “reforming reactor” refers to a reactor in which a hydrocarbon reforming reaction and, optionally, other reactions such as a water-gas shift reaction, may take place. Reactions that occur in a reforming reactor, as used herein, may be predominantly hydrocarbon reforming reactions, but need not be predominantly hydrocarbon reforming reactions. For example, a majority of reactions occurring in a “reforming reactor” may actually be shift reactions in certain instances rather than hydrocarbon reforming reactions.

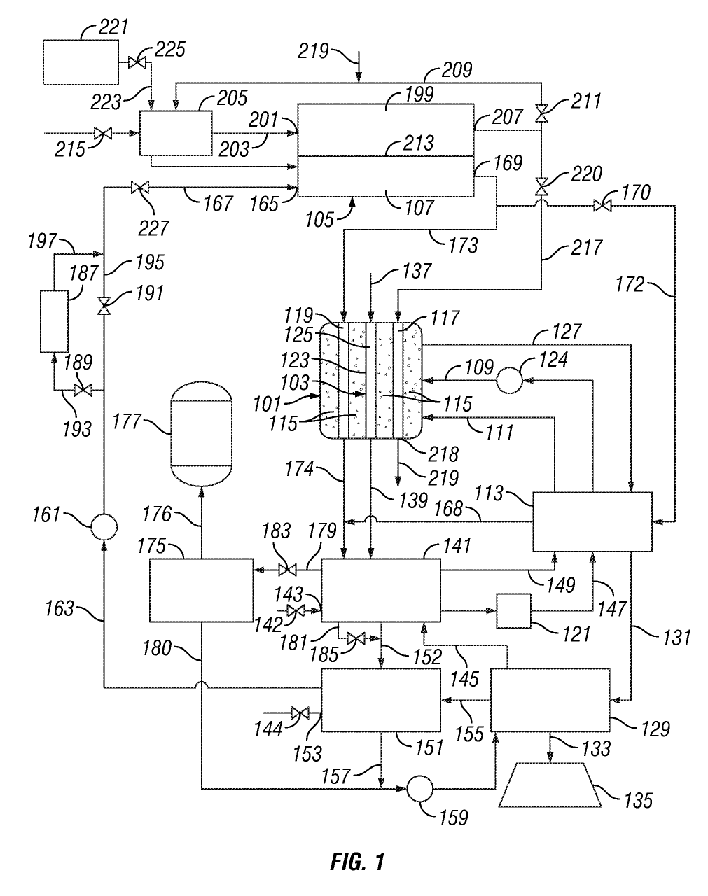

In an embodiment, the process of the present invention utilizes a system including a thermally integrated hydrogen-separating steam reforming reactor and a solid oxide fuel cell to generate electrical power. Referring to FIG. 1, a steam reforming reactor 101 including one or more high temperature hydrogen-separating membranes 103 is operatively coupled to a solid oxide fuel cell 105 to provide a first gas stream containing primarily hydrogen to the anode 107 of the fuel cell 105, while the exhaust from the fuel cell 105 provides the heat to the reforming reactor 101 necessary to drive the reforming and shift reactions in the reactor 101.

In an embodiment of the process, a feed comprising a hydrogen source that is a gaseous hydrocarbon at a temperature of at most 300° C. may be fed to the reformer 101 via line 109. Any (optionally oxygenated) hydrocarbon that is vaporized at a temperature of at most 300° C. at a pressure up to 5 MPa may be used in this embodiment of the process as the feed. Such feeds may include, but are not limited to, methane, methanol, ethane, ethanol, propane, butane, and light hydrocarbons having 1-4 carbon atoms in each molecule. In a preferred embodiment, the feed may be methane or natural gas. Steam may be fed to the reformer 101 via line 111 to be mixed with the feed in a reforming region 115 of the reformer 101.

The feed and the steam may be fed to the reformer 101 at a temperature of from 300° C. to 650° C., where the feed and steam may be heated to the desired temperature in heat exchanger 113 as described below. The feed may be desulfurized in a desulfurizer 121 prior to being heated in the heat exchanger 113, or optionally after being heated in the heat exchanger 113, but before being fed to the reforming reactor 101, to remove sulfur from the feed so the feed does not poison any catalyst in the reforming reactor 101. The feed may be desulfurized in the desulfurizer 121 by contact with a conventional hydrodesulfurizing catalyst.

The feed and steam are fed into a reforming region 115 in the reforming reactor 101. The reforming region 115 may, and preferably does, contain a reforming catalyst therein. The reforming catalyst may be a conventional steam reforming catalyst, and may be any known in the art. Typical steam reforming catalysts which can be used include, but are not limited to, Group VIII transition metals, particularly nickel. It is often desirable to support the reforming catalysts on a refractory substrate (or support). The support, if used, is preferably an inert compound. Suitable inert compounds for use as a support contain elements of Group III and IV of the Periodic Table, such as, for example the oxides or carbides of Al, Si, Ti, Mg, Ce and Zr.

The feed and steam are mixed and contacted with the reforming catalyst in the reforming region 115 at a temperature effective to form a reformed product gas containing hydrogen and carbon oxides. The reformed product gas may include compounds formed by steam reforming the hydrocarbons in the feed. The reformed product gas may also include compounds formed by shift reacting carbon monoxide produced by steam reforming with additional steam. The reformed product gas may contain hydrogen and at least one carbon oxide. Carbon oxides that may be in the reformed product gas include carbon monoxide and carbon dioxide.

One or more high temperature tubular hydrogen-separation membranes 103 may be located in the reforming region 115 of the reforming reactor 101 positioned so the reformed product gas may contact the hydrogen-separation membrane(s) 103 and hydrogen may pass through the membrane wall member 123 to a hydrogen conduit 125 located within the tubular membrane 103. The membrane wall member 123 separates the hydrogen conduit 125 from gaseous communication with non-hydrogen compounds of reformed product gas, feed, and steam in the reforming region 115, and is selectively permeable to hydrogen, elemental and/or molecular, so that hydrogen in the reformed product gas may pass through the membrane wall member 123 to the hydrogen conduit 125 while other gases in the reforming region are prevented by the membrane wall member 123 from passing to the hydrogen conduit 125.

The high temperature tubular hydrogen-separation membrane(s) 103 in the reforming region may comprise a support coated with a thin layer of a metal or alloy that is selectively permeable to hydrogen. The support may be formed of a ceramic or metallic material that is porous to hydrogen. Porous stainless steel or porous alumina are preferred materials for the support of the membrane 103. The hydrogen selective metal or alloy coated on the support may be selected from metals of Group VIII, including, but not limited to Pd, Pt, Ni, Ag, Ta, V, Y, Nb, Ce, In, Ho, La, Au, and Ru, particularly in the form of alloys. Palladium and platinum alloys are preferred. A particularly preferred membrane 103 used in the present process has a very thin film of a palladium alloy having a high surface area coating a porous stainless steel support. Membranes of this type can be prepared using the methods disclosed in U.S. Pat. No. 6,152,987. Thin films of platinum or platinum alloys having a high surface area would also be suitable as the hydrogen selective material.

The pressure within the reforming region 115 of the reforming reactor 101 is maintained at a level significantly above the pressure within the hydrogen conduit 125 of the tubular membrane 103 so that hydrogen is forced through the membrane wall member 123 from the reforming region 115 of the reforming reactor into the hydrogen conduit 125. In an embodiment, the hydrogen conduit 125 is maintained at or near atmospheric pressure, and the reforming region is maintained at a pressure of at least 0.5 MPa, or at least 1.0 MPa, or at least 2 MPa, or at least 3 MPa. The reforming region 115 may be maintained at such elevated pressures by injecting the feed and/or steam at high pressures into the reforming region 115. For example, the feed may comprise high pressure natural gas having a pressure of at least 0.5 MPa, or at least 1.0 MPa, or at least 2.0 MPa, or at least 3.0 MPa that is injected into the reforming region 115. Alternatively, after exiting the heat exchanger 113 the feed and/or steam may be compressed with compressor 124 to a pressure of at least 0.5 MPa, or at least 1.0 MPa, or at least 2.0 MPa, or at least 3.0 MPa then injected into the reforming reactor 101.

The temperature at which the feed and steam are mixed and contacted with the reforming catalyst in the reforming region 115 of the reforming reactor 101 is at least 400° C., and preferably may range from 400° C. to 650° C., most preferably in a range of from 450° C. to 550° C. Unlike typical steam reforming reactions, which produce hydrogen at temperatures in excess of 750° C., the equilibrium of the reforming reaction of the present process is driven towards the production of hydrogen in the reforming reactor 101 operating temperature range of 400° C. to 650° C. since hydrogen is removed from the reforming region 115 into the hydrogen conduit 125 of the hydrogen separation membrane(s) 103. An operating temperature of 400° C. to 650° C. favors the shift reaction as well, converting carbon monoxide and steam to more hydrogen, which is then removed from the reforming region 115 into the hydrogen conduit 125 of the hydrogen separation membrane(s) 103 through the membrane wall member 123 of the membrane(s) 103. The fuel cell 105 exhausts may be used to provide the required heat to induce the reforming and shift reactions in the reforming region 115 of the reforming reactor 101 through the exhaust conduits 117 and 119, as described in further detail below.

A non-hydrogen gaseous stream may be removed from the reforming region 115 via line 127, where the non-hydrogen gaseous stream may include unreacted feed and gaseous non-hydrogen reformed products in the reformed product gas. The non-hydrogen reformed products and unreacted feed may include carbon dioxide, water (as steam), and small amounts of carbon monoxide and unreacted hydrocarbons.

In an embodiment, the non-hydrogen gaseous stream separated from the reforming region 115 may be a carbon dioxide gas stream containing at least 0.9, or at least 0.95, or at least 0.98 mole fraction carbon dioxide on a dry basis. The carbon dioxide gas stream may be a high pressure gas stream, having a pressure of at least 1 MPa, or at least 2 MPa, or at least 2.5 MPa. The high pressure carbon dioxide gas stream may contain significant amounts of water as steam as it exits the reforming reactor 101. The water may be removed from the high pressure carbon dioxide gas stream by passing the stream through heat exchanger 113 via line 127 to exchange heat with the steam and feed being fed to the reforming reactor 101, cooling the high pressure carbon dioxide gas stream. The cooled high pressure carbon dioxide gas stream may be cooled further to condense the water from the stream in heat exchanger 129, where the cooled high pressure carbon dioxide stream may be passed to the heat exchanger 129 from heat exchanger 113 via line 131. The dry high pressure carbon dioxide stream may be removed from heat exchanger 129 via line 133. The condensed water may be fed to condenser 151 through line 155.

The dry high pressure carbon dioxide stream may be expanded through a turbine 135 to drive the turbine 135 and produce a low pressure carbon dioxide stream. Expansion of the dry high pressure carbon dioxide stream through the turbine 135 may be used to generate electricity in addition to electricity generated by the fuel cell 105. Alternatively, the turbine 135 may be used to drive a compressor 161, which may be used to compress a gas stream containing hydrogen that is fed to the fuel cell 105 as described below, and/or to drive compressor 124 to compress steam and/or feed being fed to the reforming reactor 101. The low pressure carbon dioxide stream may be sequestered or used for carbonation of beverages.

Alternatively, the high pressure carbon dioxide stream may not be converted to a low pressure carbon dioxide stream, and may be used for enhancing oil recovery from an oil formation by injecting the high pressure carbon dioxide stream into the oil formation.

A first gas stream containing hydrogen may be separated from the reformed product gas in the reforming reactor 101 by selectively passing hydrogen through the membrane wall member 123 of the hydrogen separation membrane(s) 103 into the hydrogen conduit 125 of the hydrogen separation membrane(s) 103. The first gas stream may contain a very high concentration of hydrogen, and may contain at least 0.6, or at least 0.7, or at least 0.8, or at least 0.9, or at least 0.95, or at least 0.98 mole fraction hydrogen.

A sweep gas comprising steam may be injected into the hydrogen conduit 125 via line 137 to sweep hydrogen from the inner portion of the membrane wall member 123 into the hydrogen conduit 125, thereby increasing the rate hydrogen may be separated from the reforming region 115 by the hydrogen separation membrane 103. The first gas stream and steam sweep gas may be removed from the hydrogen separation membrane 103 and the reforming reactor 101 through hydrogen outlet line 139.

The first gas stream and the steam sweep gas may be fed to a heat exchanger 141 via hydrogen outlet line 139 to cool the first gas stream and steam sweep gas. The combined first gas stream and steam sweep gas may have a temperature of from 400° C. to 650° C., typically a temperature of from 450° C. to 550° C., upon exiting the reforming reactor 101. The combined first gas stream and steam sweep gas may exchange heat with the initial feed and water/steam in the heat exchanger 141. The initial feed may be provided to the heat exchanger 141 via line 143, and water/steam may be provided to the heat exchanger 141 via line 145, where the flow rate of the feed and the water may be regulated by metering valves 142 and 144, respectively. The heated feed and steam may fed to heat exchanger 113 via lines 147 and 149, respectively, for further heating prior to being fed to the reforming reactor 101 as described above. The cooled combined first gas stream and steam sweep gas may be fed to condenser 151 through line 152 to condense water from the combined streams by exchanging heat with water fed into the condenser 151 via line 153 and condensed water separated from the high pressure carbon dioxide gas stream via line 155.

The water condensed in condenser 151 and water fed to the condenser 151 through lines 153 and 155 may be passed through water trap line 157 to a pump 159 which pumps the water to heat exchanger 129 for heat exchange with the cooled high pressure carbon dioxide gas stream to heat the water while further cooling the cooled high pressure carbon dioxide gas stream. The heated water/steam may be passed to the heat exchanger 141 via line 145, as described above, for further heating to produce steam to be fed to the reforming reactor 101 after further heating in heat exchanger 113.

The cooled first gas stream containing hydrogen and little or no water may be fed from the condenser 151 to a compressor 161 through line 163. The first gas stream may have a pressure at or near atmospheric pressure upon exiting the reforming reactor and being fed through heat exchanger 141 and condenser 151 to the compressor 161. The first gas stream may be compressed in the compressor 161 to increase the pressure of the first gas stream prior to being fed to the fuel cell 105. In an embodiment, the first gas stream may be compressed to a pressure of from 0.15 MPa to 0.5 MPa, and preferably from 0.2 MPa to 0.3 MPa. Energy to drive the compressor 161 may be provided by expansion of the high pressure carbon dioxide stream through a turbine 135 operatively coupled to drive the compressor 161.

The first gas stream may then be fed to the anode 107 of the solid oxide fuel cell 105 through line 167 into the anode inlet 165. The first gas stream provides hydrogen to the anode for electrochemical reaction with an oxidant at one or more anode electrodes along the anode path length in the fuel cell. The rate the first gas stream is fed to the anode 107 of the fuel cell 105 may be selected by selecting the rate that the feed and steam are fed to the reforming reactor 101 which may be controlled by metering valves 142 and 144.

A second gas stream containing hydrogen may also be fed to the anode 107 of the fuel cell 105. The second gas stream may be separated from the anode exhaust stream, which contains hydrogen and water. The second gas stream may be separated from the anode exhaust stream by cooling the anode exhaust stream sufficiently to condense water from the anode gas exhaust stream to produce the second gas stream containing hydrogen.

The anode exhaust stream exits the anode 107 through the anode exhaust outlet 169. The anode exhaust stream may be initially cooled by exchanging heat with steam and feed in the reforming reactor. In an embodiment, the anode exhaust stream may be initially cooled by being fed through line 173 to one or more reformer anode exhaust conduits 119 extending into and located within the reforming region 115 of the reforming reactor 105. Heat may be exchanged between the anode exhaust stream and the feed and steam in the reforming region 115 of the reforming reactor 101 as the anode exhaust stream passes through the reforming region 115 in the reformer anode exhaust conduit 119, as described in further detail below, cooling the anode exhaust stream and heating the steam and feed in the reactor 101.

After exchanging heat with the feed and steam in the reforming region 115 of the reforming reactor 101, the cooled anode exhaust stream may exit the anode exhaust conduit 119 and may be cooled further to separate the second gas stream containing hydrogen from water in the anode exhaust stream. In one embodiment, to control the flow rate of the second gas stream to the fuel cell 105, at least a portion of the anode exhaust stream may be passed to heat exchanger 141 via line 174 to further cool the selected portion of the anode exhaust stream by exchange of heat with the feed from line 143 and steam from line 145, then fed to a condenser 175 to further cool the selected portion of the anode exhaust stream. Hydrogen may be separated from the selected portion of the anode exhaust stream by condensing water from the anode exhaust stream in the condenser 175. The separated hydrogen may be fed to a hydrogen storage tank 177 through line 179. Water condensed from condenser 175 may be fed to pump 159 through line 180.

Cooled anode exhaust stream not fed to condenser 175 for separation into the hydrogen tank is used to provide the second gas stream to the fuel cell 105. The cooled anode exhaust stream may be passed to heat exchanger 141 via line 174 to further cool the anode exhaust stream by exchange of heat with the feed from line 143 and steam from line 145, then mixed with the first gas stream and steam sweep gas by feeding the anode exhaust stream through line 181 to line 152. The mixture of anode exhaust stream, first gas stream, and steam sweep gas may be then fed to condenser 151 to further cool the anode exhaust stream. The second gas stream, derived from condensing water from the anode exhaust stream, may be separated from the condenser 151 via line 163 mixed together with the first gas stream. The second gas stream may contain at least 0.6, or at least 0.7, or at least 0.8, or at least 0.9, or at least 0.95, or at least 0.98 mole fraction hydrogen, where the hydrogen content of the second gas stream may be determined by determining the hydrogen content of the cooled anode exhaust stream on a dry basis. Water from the anode exhaust stream may be condensed in condenser 151 together with water from the first gas stream and the steam sweep gas, and removed from the condenser 151 through line 157 to be fed to pump 159.

Metering valves 183 and 185 may be used to select the rate of flow of the second gas stream to the solid oxide fuel cell 105. In order to block the flow of a second gas stream to the fuel cell and to store hydrogen in the hydrogen tank 177, valve 185 may be completely closed, blocking flow of the anode exhaust stream to the condenser 151 and the second gas stream to the solid oxide fuel cell while valve 183 may be completely opened to allow the anode exhaust stream to flow to condenser 175 and hydrogen to the hydrogen tank 177. Alternatively, valve 183 may be completely closed, blocking flow of the anode exhaust stream to condenser 175 and hydrogen to the hydrogen tank 177, and valve 185 may be completely opened to allow the entire anode exhaust stream to flow to the condenser 151 and the second gas stream to flow to the solid oxide fuel cell 105 at a maximum flow rate. The flow rate of the second gas stream to the solid oxide fuel cell may be selected by adjusting valves 183 and 185 in coordination to meter the flow rate of the anode exhaust stream to condenser 151 and the rate of the second gas stream to the solid oxide fuel cell 105. In a preferred embodiment, the flow rate of the second gas stream to the fuel cell 105 may be automatically controlled to a selected rate by automatically adjusting the metering valves 183 and 185 in response to the water and/or hydrogen content of the anode exhaust stream.

In an embodiment, when the first and second gas streams are combined by adjusting valves 183 and 185 as described above, a small portion of the combined first and second gas streams may be passed through a hydrogen separation device 187 as a bleed stream to remove any small amounts of carbon oxides that may be present in the combined first and second gas streams as a result of imperfect separation of hydrogen from carbon oxides by the hydrogen separation membrane 103 in the reforming reactor 101 when producing the first gas stream and its subsequent recycle in the second gas stream. Valves 189 and 191 may be utilized to control the flow of the bleed stream to the hydrogen separation device 187, where preferably valves 189 and 191 may permit a metered flow of the combined first and second gas streams simultaneously through lines 193 and 195, or, alternatively, separately through either line 193 or line 195. The hydrogen separation device 187 is preferably a pressure swing adsorption apparatus effective for separating hydrogen from carbon oxides, or may be a membrane selectively permeable to hydrogen such as those described above. The first and second gas streams in lines 195 and 197 may be combined to be fed to the solid oxide fuel cell 105 through line 167.

In an embodiment of the process, the temperature of the first gas stream or the combined first and second gas streams and pressure of the first gas stream or the combined first and second gas streams may be selected for effective operation of the solid oxide fuel cell 105, and, in particular, the temperature should not be so low as to inhibit the electrochemical reactivity of the fuel cell and should not be so high as to induce an uncontrolled exothermic reaction in the fuel cell 105. In an embodiment, the temperature of the first gas stream or the combined first and second gas streams may range from 25° C. to 300° C., or from 50° C. to 200° C., or from 75° C. to 150° C. The pressure of the first gas stream or the combined first and second streams may be controlled by the compression provided to the combined first and second gas streams by compressor 161, and may be from 0.15 MPa to 0.5 MPa, or from 0.2 MPa to 0.3 MPa.

An oxygen containing gas stream may be fed to the cathode 199 of the fuel cell through cathode inlet 201 via line 203. The oxygen containing gas stream may be provided by an air compressor or an oxygen tank (not shown). In an embodiment, the oxygen containing gas stream may be air or pure oxygen. In another embodiment, the oxygen containing gas stream may be an oxygen enriched air stream containing at least 21% oxygen, where the oxygen enriched air stream provides higher electrical efficiency in the solid oxide fuel cell than air since the oxygen enriched air stream contains more oxygen for conversion into ionic oxygen in the fuel cell.

The oxygen containing gas stream may be heated prior to being fed to the cathode 199 of the fuel cell 105. In one embodiment, the oxygen containing gas stream may be heated to a temperature of from 150° C. to 350° C. prior to being fed to the cathode 199 of the fuel cell 105 in heat exchanger 205 by exchanging heat with a portion of the cathode exhaust provided to the heat exchanger from the cathode exhaust outlet 207 via line 209. The flow rate of the cathode exhaust stream to the heat exchanger 205 may be controlled with metering valve 211. Alternatively, the oxygen containing gas stream may be heated by an electrical heater (not shown), or the oxygen containing gas stream may be provided to the cathode 199 of the fuel cell 105 without heating.

The solid oxide fuel cell 105 used in this embodiment of the process of the invention may be a conventional solid oxide fuel cell, preferably having a planar or tubular configuration, and is comprised of an anode 107, a cathode 199, and an electrolyte 213 where the electrolyte 213 is interposed between the anode 107 and the cathode 199. The solid oxide fuel cell may be comprised of a plurality of individual fuel cells stacked together-joined electrically by interconnects and operatively connected so that a fuel may flow through the anodes of the stacked fuel cells and an oxygen containing gas may flow through the cathodes of the stacked fuel cells. As used herein, the term “solid oxide fuel cell” is defined as either a single solid oxide fuel cell or a plurality of operatively connected or stacked solid oxide fuel cells. In an embodiment, the anode 107 is formed of a Ni/ZrO₂ cermet, the cathode 199 is formed of a doped lanthanum manganite or stabilized ZrO₂ impregnated with praseodymium oxide and covered with SnO doped In₂O₃, and the electrolyte 213 is formed of yttria stabilized ZrO₂ (approximately 8 mol % Y₂O₃). The interconnect between stacked individual fuel cells or tubular fuel cells may be a doped lanthanum chromite.

The solid oxide fuel cell 105 is configured so that the first gas stream or the combined first and second gas streams may flow through the anode 107 of the fuel cell 105 from the anode inlet 165 to the anode exhaust outlet 169, contacting one or more anode electrodes over the anode path length from the anode inlet 165 to the anode exhaust outlet 169. The fuel cell 105 is also configured so that the oxygen containing gas may flow through the cathode 199 from the cathode inlet 201 to the cathode exhaust outlet 207, contacting one or more cathode electrodes over the cathode path length from the cathode inlet 201 to the cathode exhaust outlet 207. The electrolyte 213 is positioned in the fuel cell 105 to prevent the first gas stream or combined first and second gas stream from entering the cathode and to prevent the oxygen containing gas from entering the anode, and to conduct ionic oxygen from the cathode to the anode for electrochemical reaction with hydrogen in the first gas stream or the combined first and second gas streams at the one or more anode electrodes.

The solid oxide fuel cell 105 is operated at a temperature effective to enable ionic oxygen to traverse the electrolyte 213 from the cathode 199 to the anode 107 of the fuel cell 105. The solid oxide fuel cell 105 may be operated at a temperature of from 700° C. to 1100° C., or from 800° C. to 1000° C. The oxidation of hydrogen with ionic oxygen at the one or more anode electrodes is a very exothermic reaction, and the heat of reaction generates the heat required to operate the solid oxide fuel cell 105. The temperature at which the solid oxide fuel cell is operated may be controlled by independently controlling the temperature of the first gas stream, the temperature of the second gas stream fed to the fuel cell (if any), and the oxygen containing gas stream, and the flow rates that these streams are fed to the fuel cell 105. In an embodiment, the temperature of the second gas stream fed to the fuel cell is controlled to a temperature of at most 100° C., the temperature of the oxygen containing gas stream is controlled to a temperature of at most 300° C., and the temperature of the first gas stream is controlled to a temperature of at most 550° C. to maintain the operating temperature of the solid oxide fuel cell in a range from 700° C. to 1000° C., and preferably in a range of from 800° C. to 900° C.

To initiate operation of the fuel cell 105, the fuel cell 105 is heated to its operating temperature. In a preferred embodiment, operation of the solid oxide fuel cell 105 may be initiated by generating a hydrogen containing gas stream in a catalytic partial oxidation reforming reactor 221 and feeding the hydrogen containing gas stream through line 223 to the anode 107 of the solid oxide fuel cell. A hydrogen containing gas stream may be generated in the catalytic partial oxidation reforming reactor by combusting a hydrocarbon feed and an oxygen source in the catalytic partial oxidation reforming reactor 221 in the presence of a conventional partial oxidation reforming catalyst, where the oxygen source is fed to the catalytic partial oxidation reforming reactor in a substoichiometric amount relative to the hydrocarbon feed.

The hydrocarbon feed fed to the catalytic partial oxidation reforming reactor 221 may be a liquid or gaseous hydrocarbon or mixtures of hydrocarbons, and preferably is methane, natural gas, or other low molecular weight hydrocarbon or mixture of low molecular weight hydrocarbons. In a particularly preferred embodiment of the process of the invention, the hydrocarbon feed fed to the catalytic partial oxidation reforming reactor 221 may be a feed of the same type as used in the reforming reactor 101 to reduce the number of hydrocarbon feeds required run the process.

The oxygen containing feed fed to the catalytic partial oxidation reforming reactor 221 may be pure oxygen, air, or oxygen enriched air. The oxygen containing feed should be fed to the catalytic partial oxidation reforming reactor 221 in substoichiometric amounts relative to the hydrocarbon feed to combust with the hydrocarbon feed in the catalytic partial oxidation reforming reactor 221.

The hydrogen containing gas stream formed by combustion of the hydrocarbon feed and the oxygen containing gas in the catalytic partial oxidation reforming reactor 221 contains compounds that may be oxidized in the anode 107 of the fuel cell 105 by contact with an oxidant at one or more of the anode electrodes, including hydrogen and carbon monoxide, as well as other compounds such as carbon dioxide. The hydrogen containing gas steam from the catalyst partial oxidation reforming reactor 221 preferably does not contain compounds that may oxidize the one or more anode electrodes in the anode 107 of the fuel cell 105.

The hydrogen containing gas stream formed in the catalytic partial oxidation reforming reactor 221 is hot, and may have a temperature of at least 700° C., or from 700° C. to 1100° C., or from 800° C. to 1000° C. Use of the hot hydrogen containing gas stream from the catalytic partial oxidation reforming reactor 221 to initiate start up of the solid oxide fuel cell 105 is preferred in the process of the invention since it enables the temperature of the fuel cell 105 to be raised to the operating temperature of the fuel cell 105 almost instantaneously. In an embodiment, heat may be exchanged in heat exchanger 205 between the hot hydrogen containing gas from the catalytic partial oxidation reforming reactor and an oxygen containing gas fed to the cathode 199 of the fuel cell 105 when initiating operation of the fuel cell 105 to heat the oxygen containing gas.

Upon reaching the operating temperature of the fuel cell 105, the flow of the hot hydrogen containing gas stream from the catalytic partial oxidation reforming reactor 221 into the fuel cell 105 may be shut off by valve 225, while feeding the first gas stream from the reforming reactor 101 into the anode 107 by opening valve 227. Continuous operation of the fuel cell may then conducted according to the process of the invention.

In another embodiment (not shown in FIG. 1), operation of the fuel cell may be initiated with a hydrogen start-up gas stream from the hydrogen storage tank 177, where the hydrogen start-up gas stream is passed through a start-up heater to bring the fuel cell up to its operating temperature prior to introducing the first gas stream into the fuel cell. The hydrogen storage tank 177 may be operatively connected to the fuel cell to permit introduction of the hydrogen start-up gas stream into the anode of the solid oxide fuel cell. The start-up heater may indirectly heat the hydrogen start-up gas stream to a temperature of from 750° C. to 1000° C. The start-up heater may be an electrical heater or may be a combustion heater. Upon reaching the operating temperature of the fuel cell, the flow of the hydrogen start-up gas stream into the fuel cell may be shut off by a valve, and the first gas stream and the oxygen containing gas stream may be introduced into the fuel cell to start the operation of the fuel cell.

Referring again to FIG. 1, during initiation of operation of the fuel cell 105, a oxygen containing gas stream may be introduced into the cathode 199 of the fuel cell 105. The oxygen containing gas stream may be air, oxygen enriched air containing at least 21% oxygen, or pure oxygen. Preferably, the oxygen containing gas stream is the oxygen containing gas stream that will be fed to the cathode 199 during operation of the fuel cell 105 after initiating operation of the fuel cell.

In a preferred embodiment, the oxygen containing gas stream fed to the cathode 199 of the fuel cell during start-up of the fuel cell has a temperature of at least 500° C., more preferably at least 650° C., and more preferably at least 750° C. The oxygen containing gas stream may be heated by an electric heater before being fed to the cathode 199 of the solid oxide fuel cell 105. In a preferred embodiment, the oxygen containing gas stream used in initiating operation of the fuel cell 105 may be heated by heat exchange with the hot hydrogen containing gas stream from a catalytic partial oxidation reforming reaction in heat exchanger 205 prior to being fed to the cathode 199 of the fuel cell 105.

Once operation of the fuel cell 105 has commenced, the first gas stream or the combined first and second gas streams may be mixed with an ionic oxygen oxidant at one or more anode electrodes in the fuel cell 105 to generate electricity. The ionic oxygen oxidant is derived from oxygen in the oxygen-containing gas stream flowing through the cathode 199 of the fuel cell 105 and conducted across the electrolyte 213 of the fuel cell. The first gas stream or the combined first and second gas streams fed to the anode 107 of the fuel cell 105 and the oxidant are mixed in the anode 107 at the one or more anode electrodes of the fuel cell 105 by feeding the first gas stream, the second gas stream (if any), and the oxygen containing gas stream to the fuel cell 105 at selected independent rates while operating the fuel cell at a temperature of from 750° C. to 1100° C.

The first gas stream or the combined first and second gas streams and the oxidant are preferably mixed at the one or more anode electrodes of the fuel cell 105 to generate electricity at an electrical power density of at least 0.4 W/cm², more preferably at least 0.5 W/cm², or at least 0.75 W/cm², or at least 1 W/cm², or at least 1.25 W/cm², or at least 1.5 W/cm². Electricity may be generated at such electrical power densities by selecting and controlling the rate that the first gas stream is fed to the anode 107 of the fuel cell 105 or independently selecting and controlling the flow rates of the first gas stream and the second gas stream to the anode 109 of the fuel cell 105. The flow rate of the first gas stream to the anode 107 of the fuel cell 105 may be selected and controlled by selecting and controlling the rate that the feed and steam are fed to the reforming reactor by adjusting metering valves 142 and 144. The flow rate of the second gas stream to the anode 107 of the fuel cell 105 may be selected and controlled by selecting and controlling the flow rate of the anode exhaust stream to the condenser 151 by adjusting metering valves 183 and 185 as described above. In an embodiment, metering valves 183 and 185 may be automatically adjusted by a feedback circuit (not shown) that measures water and/or hydrogen content in the anode exhaust stream to select the rate the second gas stream is fed to the fuel cell 105, and adjusts the metering valves 183 and 185 to maintain a selected water and/or hydrogen content in the anode exhaust stream by adjusting the rate that the second gas stream is fed to the fuel cell 105.

In the process of the invention, mixing the first gas stream or the combined first and second gas streams and the oxidant at the one or more anode electrodes generates water (as steam) by the oxidation of a portion of hydrogen present in the first gas stream or the combined first and second gas streams fed to the fuel cell 105 with the oxidant. Water generated by the oxidation of hydrogen with an oxidant is swept through the anode 107 of the fuel cell 105 by the unreacted portion of the first gas stream or the combined first and second gas streams to exit the anode 107 as part of the anode exhaust stream.

In an embodiment of the process of the invention, the flow rate that the first gas stream is fed to the anode 107 and, if a second gas stream is provided to the anode 107, the flow rate that the second gas stream is fed to the anode 107 may be independently selected so the ratio of amount of water formed in the fuel cell per unit of time to the amount of hydrogen in the anode exhaust per unit of time is at most 1.0, or at most 0.75, or at most 0.67, or at most 0.43, or at most 0.25, or at most 0.11. In an embodiment, the amount of water formed in the fuel cell and the amount of hydrogen in the anode exhaust may be measured in moles so that the ratio of the amount of water formed in the fuel cell per unit of time to the amount of hydrogen in the anode exhaust per unit of time in moles per unit of time is at most 1.0, or at most 0.75, or at most 0.67, or at most 0.43, or at most 0.25, or at most 0.11. In another embodiment of the process of the invention, the flow rate that the first gas stream is fed to the anode 107 and, if a second gas stream is provided to the anode 107, the flow rate that the second gas stream is fed to the anode 107 may be independently selected so the anode exhaust stream contains at least 0.6, or at least 0.7, or at least 0.8, or at least 0.9 mole fraction hydrogen. In an embodiment, the flow rate that the first gas stream is fed to the anode 107 and, if a second gas stream is provided to the anode, the flow rate that the second gas stream is fed to the anode 107 may be independently selected so the anode exhaust stream contains at least 50%, or at least 60%, or at least 70%, or at least 80%, or at least 90% of the hydrogen in the combined first and second gas streams fed to the anode 107, or, if only the first gas stream is provided to the anode 107, the anode exhaust stream contains at least 50%, or at least 60%, or at least 70%, or at least 80%, or at least 90% of the hydrogen in the first gas stream provided to the anode 107. In an embodiment, the flow rate that the first gas stream is fed to the anode 107, and, if a second gas stream is provided to the anode 107, the flow rate that the second gas stream is provided to the anode 107 may be independently selected so the per pass hydrogen utilization in the fuel cell is at most 50%, or at most 40%, or at most 30%, or at most 20%, or at most 10%.

The flow rate of the oxygen containing gas stream provided to the cathode 199 of the solid oxide fuel cell 105 should be selected to provide sufficient oxidant to the anode to generate electricity at an electrical power density of at least 0.4 W/cm², or at least 0.5 W/cm², or at least 0.75 W/cm², or at least 1 W/cm², or at least 1.25 W/cm², or at least 1.5 W/cm² when combined with the fuel from the first gas stream or the combined first and second gas streams at the one or more anode electrodes. The flow rate of the oxygen containing gas stream to the cathode 199 may be selected and controlled by adjusting metering valve 215.

The reforming reactor 101 and the solid oxide fuel cell 105 may be thermally integrated so the heat from the exothermic electrochemical reaction in the fuel cell 105 is provided to the reforming region 115 of the reforming reactor 101 to drive the endothermic reforming reaction in the reforming reactor 101. As described above, one or more anode exhaust conduits 119 and/or one or more cathode exhaust conduits 117 extend into and are located within the reforming region 115 of the reforming reactor 101. A hot anode exhaust stream may exit the anode 107 of the fuel cell 105 from the anode exhaust outlet 169 and enter the anode exhaust conduit 119 in the reforming region 115 via line 173, and/or a hot cathode exhaust stream may exit the cathode 199 of the fuel cell 105 from the cathode exhaust outlet 207 and enter the cathode exhaust conduit 117 in the reforming region 115 via line 217. Heat from the hot anode exhaust stream may be exchanged between the anode exhaust stream and the mixture of steam and feed in the reforming region 115 as the anode exhaust stream passes through the anode exhaust conduit 119. Likewise, heat from the hot cathode exhaust stream may be exchanged between the cathode exhaust stream and the mixture of steam and feed in the reforming region 115 of the reforming reactor 101 as the cathode exhaust stream passes through the cathode exhaust conduit 117.

The heat exchange from the exothermic solid oxide fuel cell 105 to the endothermic reforming reactor 101 is highly efficient. Location of the anode exhaust conduit(s) 119 and/or the cathode exhaust conduit(s) 117 within the reforming region 115 of the reforming reactor 101 permits exchange of heat between the hot anode and/or cathode exhaust streams and the mixture of feed and steam within the reactor 101, transferring heat to the feed and steam at the location that the reforming reaction takes place. Further, location of the anode and/or cathode exhaust conduits 119 and 117 within the reforming region 115 permits the hot anode and/or cathode exhaust streams to heat the reforming catalyst in the reforming region 115 as a result of the close proximity of the conduits 117 and 119 to the catalyst bed.

Further, no additional heat other than provided by either 1) the anode exhaust stream; or 2) the cathode exhaust stream; or 3) the anode exhaust stream in combination with the cathode exhaust stream, needs to be provided to the reforming reactor 101 to drive the reforming and shift reactions in the reactor 101 to produce the reformed product gas and the first gas stream. As noted above, the temperature required to run the reforming and shift reactions within the reforming reactor 101 is from 400° C. to 650° C., which is much lower than conventional reforming reactor temperatures—which are at least 750° C., and typically 800° C.-900° C. The reforming reactor may be run at such low temperatures due to the equilibrium shift in the reforming reaction engendered by separation of hydrogen from the reforming reactor 101 by the high temperature hydrogen separation membrane 103. The anode exhaust stream and the cathode exhaust stream may have a temperature of from 800° C. to 1000° C., which, upon heat exchange between the anode exhaust stream and/or the cathode exhaust stream and the mixture of feed and steam, is sufficient to drive the lower temperature reforming and shift reactions in the reforming reactor 101.

In an embodiment of the process of the invention, the exchange of heat between the anode exhaust stream and the mixture of steam and feed in the reforming region 115 as the anode exhaust stream passes through the anode exhaust conduit 119 may provide a significant amount of the heat provided to the mixture of steam and feed in the reactor 101 to drive the reforming and shift reactions. In an embodiment of the process of the invention, the exchange of heat between the anode exhaust stream and the mixture of steam and feed in the reactor 101 may provide at least 40%, or at least 50%, or at least 70%, or at least 90% of the heat provided to the mixture of steam and feed in the reactor 101. In an embodiment, the heat supplied to the mixture of steam and feed in the reforming reactor 101 consists essentially of the heat exchanged between the anode exhaust stream passing through the anode exhaust conduit 119 and the mixture of steam and feed in the reforming reactor 101. In an embodiment of the process, the exchange of heat between the anode exhaust stream and the mixture of steam and feed in the reactor 101 may be controlled to maintain the temperature of the mixture of steam and feed in a range of from 400° C. to 650° C.

In an embodiment of the process of the invention, the exchange of heat between the cathode exhaust stream and the mixture of steam and feed in the reforming region 115 as the cathode exhaust stream passes through the cathode exhaust conduit 119 may provide a significant amount of the heat provided to the mixture of steam and feed in the reactor 101 to drive the reforming and shift reactions. In an embodiment of the process of the invention, the exchange of heat between the cathode exhaust stream and the mixture of steam and feed in the reactor 101 may provide at least 40%, or at least 50%, or at least 70%, or at least 90% of the heat provided to the mixture of steam and feed in the reactor 101. In an embodiment, the heat supplied to the mixture of steam and feed in the reforming reactor 101 consists essentially of the heat exchanged between the cathode exhaust stream passing through the cathode exhaust conduit 119 and the mixture of steam and feed in the reforming reactor 101. In an embodiment of the process, the exchange of heat between the cathode exhaust stream and the mixture of steam and feed in the reactor 101 may be controlled to maintain the temperature of the mixture of steam and feed in a range of from 400° C. to 650° C.

In an embodiment, the exchange of heat between the anode exhaust stream, the cathode exhaust stream, and the mixture of steam and feed in the reforming region 115 as the anode exhaust stream passes through the anode exhaust conduit 119 and the cathode exhaust stream passes through the cathode exhaust conduit 117 may provide a significant amount of the heat provided to the mixture of steam and feed in the reactor 101 to drive the reforming and shift reactions. In an embodiment of the process of the invention, the exchange of heat between the cathode exhaust stream and the mixture of steam and feed in the reactor 101 may provide up to 60%, or up to 50%, or up to 40%, or up to 30%, or up to 20% of the heat provided to the mixture of steam and feed in the reactor 101 while the exchange of heat between the anode exhaust stream and the mixture of steam and feed may provide at least 40%, or at least 50%, or at least 60%, or at least 70%, or at least 80% of the heat provided to the mixture of steam and feed in the reactor 101. In an embodiment, the heat supplied to the mixture of steam and feed in the reforming reactor 101 may consist essentially of heat exchanged between the anode and cathode exhaust streams and the mixture of steam and feed in the reactor 101. In an embodiment of the process, the exchange of heat between the anode and cathode exhaust streams and the mixture of steam and feed in the reactor 101 may be controlled to maintain the temperature of the mixture of steam and feed in a range of from 400° C. to 650° C.

In a preferred embodiment, the heat provided by the anode exhaust stream or the anode and cathode exhaust streams to the mixture of steam and feed in the reforming reactor 101 is sufficient to drive the reforming and shift reactions in the reforming reactor 101 such that no other source of heat is required to drive the reactions in the reforming reactor 101. Most preferably, no heat is provided to the mixture of steam and feed in the reactor 101 by combustion.

In an embodiment, the anode exhaust stream provides most, or all, of the heat to the mixture of steam and feed in the reforming reactor 101 to drive the reforming and shift reactions in the reactor. In this embodiment only some, or none, of the cathode exhaust stream is required to exchange heat with the mixture of steam and feed in the reforming reactor 101 to drive the reforming and shift reactions. The flow of the cathode exhaust stream through the cathode exhaust conduit 117 in the reforming reactor may be controlled to control the amount of heat provided to the mixture of steam and feed in the reforming reactor 101 from the cathode exhaust stream. Metering valves 211 and 220 may be adjusted to control the flow of the cathode exhaust stream to the cathode exhaust conduit 117 such that the cathode exhaust stream provides the desired amount of heat, if any, to the mixture of steam and feed in the reactor 101. Cathode exhaust stream that is not required to heat the mixture of steam and feed in the reactor 101 may be shunted through line 209 to heat exchanger 205 to heat the oxygen containing gas fed to the cathode.

In an embodiment, the cathode exhaust stream provides most, or all, of the heat to the mixture of steam and feed in the reforming reactor 101 to drive the reforming and shift reactions in the reactor. In this embodiment only some, or none, of the anode exhaust stream is required to exchange heat with the mixture of steam and feed in the reforming reactor 101 to drive the reforming and shift reactions. The flow of the anode exhaust stream through the anode exhaust conduit 119 in the reforming reactor may be controlled to control the amount of heat provided to the mixture of steam and feed in the reforming reactor 101 from the anode exhaust stream. The portion of the anode exhaust stream not used to provide heat to the reforming reactor 101 may be fed through heat exchanger 113 to heat the feed and steam entering the reforming reactor 101 and cool the anode exhaust stream prior to being combined with the first gas stream and steam sweep gas for further cooling in heat exchanger 141.

The cooled cathode exhaust stream that has passed through the cathode exhaust conduit 117 may still have a significant amount of heat therein, and may have a temperature of up to 650° C. The cooled cathode exhaust stream may be passed out of the cathode exhaust conduit through outlet 218 to be fed to the oxygen containing gas heat exchanger 205 through line 219 along with any cathode exhaust stream metered to the heat exchanger 205 through valve 211.

In this embodiment of the process of the present invention, relatively little carbon dioxide is generated per unit of electricity produced by the process. The thermal integration of the reforming reactor 101 with the fuel cell 105—wherein the heat produced in the fuel cell 105 is transferred within the reforming reactor 101 by the anode and/or cathode exhausts from the fuel cell 105—reduces the energy required to be provided to drive the endothermic reforming reaction, reducing the need to provide such energy, for example by combustion, thereby reducing the amount of carbon dioxide produced in providing energy to drive the reforming reaction. Additionally, where the second gas stream is separated from the anode exhaust stream and recycled back to the fuel cell 105 as fuel, the hydrogen from the anode exhaust stream in the second gas stream to the fuel cell 105 reduces the amount of hydrogen required to be produced by the reforming reactor 101, thereby reducing attendant carbon dioxide by-product production.

In this embodiment of the process of the present invention, carbon dioxide is generated at a rate of no more than 400 grams per kilowatt-hour (400 g per kWh) of electricity generated. In a preferred embodiment, carbon dioxide is generated in the process of the present invention at a rate of no more than 350 g per kWh, and in a more preferred embodiment, carbon dioxide is generated in the process of the present invention at a rate of no more than 300 g per kWh.

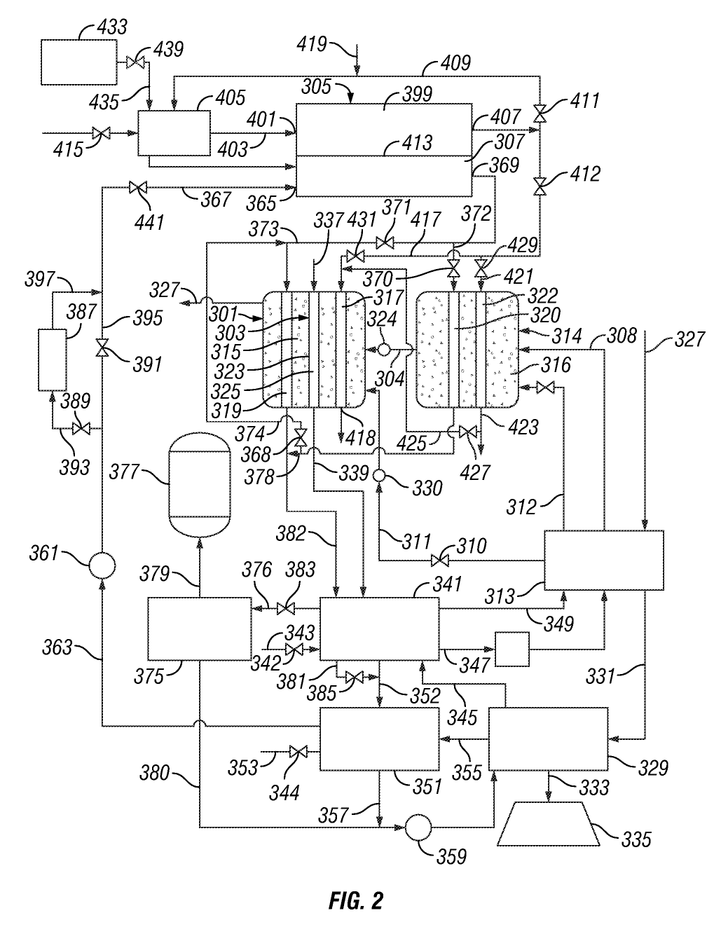

In another embodiment, as shown in FIG. 2, the process of the present invention may use a liquid hydrocarbon feed precursor that may be hydrocracked, and in an embodiment partially reformed, to a gaseous hydrocarbon feed in a pre-reforming reactor 314 which may then be reformed in a hydrogen-separating steam reforming reactor 301 to produce hydrogen which may be utilized to generate electricity in a solid oxide fuel cell 305. The process is thermally integrated, where heat to drive the endothermic pre-reforming reactor 314 and reforming reactor 301 may be provided from the exothermic solid oxide fuel cell 305 directly within the pre-reforming reactor 314 and/or the reforming reactor 301.

A steam reforming reactor 301 including one or more high temperature hydrogen-separating membranes 303 is operatively coupled to a solid oxide fuel cell 305 to provide a first gas stream containing primarily hydrogen to the anode 307 of the fuel cell 305 so that electricity may be generated in the fuel cell 305. A pre-reforming reactor 314 is operatively coupled to the steam reforming reactor 301 to provide a gaseous hydrocarbon feed to the reforming reactor 301 from a liquid hydrocarbon feed. The fuel cell 305 is operatively coupled to the reforming reactor 301 and the pre-reforming reactor 314 so the fuel cell 305 may provide the heat to the reforming reactor 301 necessary to drive the reforming and shift reactions in the reactor 301 and may provide the heat to the pre-reforming reactor 314 necessary to convert a liquid hydrocarbon feed precursor into a gaseous hydrocarbon feed that may be reformed in the reforming reactor 301.

In this process, a feed precursor comprising a hydrogen source that contains a liquid hydrocarbon may be fed to the pre-reforming reactor 314 via line 308. The feed precursor may contain one or more of any vaporizable hydrocarbon that is liquid at 20° C. at atmospheric pressure (optionally oxygenated) that is vaporizable at temperatures up to 400° C. at atmospheric pressure. Such feed precursors may include, but are not limited to, light petroleum fractions such as naphtha, diesel, and kerosene having boiling point range of 50-205° C. The feed precursor may optionally contain some hydrocarbons that are gaseous at 25° C. such as methane, ethane, propane, or other compounds containing from one to four carbon atoms that are gaseous at 25° C. In a preferred embodiment, the feed precursor may be diesel fuel. Steam may be fed to the pre-reformer 314 via line 312 to be mixed with the feed precursor in a pre-reforming region 316 of the pre-reformer 314.

The feed precursor and the steam may be fed to the pre-reformer 314 at a temperature of from 250° C. to 650° C., where the feed precursor and steam may be heated to the desired temperature in heat exchanger 313 as described below. The feed precursor may be hydrocracked and vaporized to form the gaseous hydrocarbon feed in the pre-reforming reactor 314 as described more fully below. In an embodiment, the feed precursor may be partially reformed as it is hydrocracked and vaporized to form the feed. Feed and steam from the pre-reforming reactor 314 may be fed to the reforming reactor 301 at a temperature of from 300° C. to 650° C.

The feed precursor may be desulfurized in a desulfurizer 321 prior to being heated in the heat exchanger 313, or optionally after being heated in the heat exchanger 313, but before being fed to the pre-reforming reactor 314, to remove sulfur from the feed precursor so the feed precursor does not poison any catalyst in the pre-reforming reactor 314. The feed precursor may be desulfurized in the desulfurizer 321 by contact with a conventional hydrodesulfurizing catalyst under conventional desulfurizing conditions.

The feed precursor and steam are fed into a pre-reforming region 316 in the pre-reforming reactor 314. The pre-reforming region 316 may, and preferably does, contain a pre-reforming catalyst therein. The pre-reforming catalyst may be a conventional pre-reforming catalyst, and may be any known in the art. Typical pre-reforming catalysts which can be used include, but are not limited to, Group VIII transition metals, particularly nickel and a support or substrate that is inert under high temperature reaction conditions. Suitable inert compounds for use as a support for the high temperature pre-reforming/hydrocracking catalyst include, but are not limited to, α-alumina and zirconia.

The feed precursor and steam are mixed and contacted with the pre-reforming catalyst in the pre-reforming region 316 of the pre-reforming reactor 314 at a temperature effective to vaporize the feed precursor to form the feed. Mixing and contacting the feed precursor and steam in the pre-reforming reactor 314 with a pre-reforming catalyst at a temperature effective to vaporize the feed precursor may crack hydrocarbons in the feed precursor to reduce the carbon chain length of the hydrocarbons so that the cracked hydrocarbons may be easily steam reformed in the reforming reactor 301. In an embodiment, the feed precursor and steam are mixed and contacted with the pre-reforming catalyst at a temperature of at least 600° C., or from 700° C. to 1000° C., or from 700° C. to 900° C.; and at a pressure of from 0.1 MPa to 3 MPa, preferably from 0.1 MPa to 1 MPa, or from 0.2 MPa to 0.5 MPa (correct temperature ranges?). As discussed below, heat is supplied to drive the endothermic pre-reforming reaction from the anode exhaust stream and/or from the cathode exhaust stream of the fuel cell 305 through one or more pre-reformer anode exhaust conduits 320 and/or one or more pre-reformer cathode exhaust conduits 322, respectively, extending into the pre-reforming region 316 of the pre-reforming reactor 314.

In an embodiment, an excess of steam may be fed to the pre-reforming reactor 314 relative to the amount of hydrocarbons fed to the pre-reforming reactor 314 in the feed precursor. The excess steam may prevent the pre-reforming catalyst from being coked during the pre-reforming reaction. The excess steam may also be fed to the steam reforming reactor 301 from the pre-reforming reactor 314 along with the feed produced in the pre-reforming reactor, where the steam fed to the reforming reactor 301 may be used in the reforming reactor 301 in the reforming reactions and shift reactions in the reforming reactor 301. The ratio of amount of steam fed to the pre-reforming reactor relative to the amount of feed precursor, in volume or in moles, may be at least 2:1 or at least 3:1, or at least 4:1, or at least 5:1.

The feed precursor vaporized, optionally cracked, and optionally partially reformed in the pre-reforming reactor 314 forms the feed that may be fed to the reforming reactor 301. The temperature and pressure conditions in the pre-reforming region 316 of the pre-reforming reactor 314 may be selected so the feed formed in the pre-reforming reactor 314 contains primarily light hydrocarbons that are gaseous at 25° C., typically containing from one to four carbons in each molecule. The feed formed in the pre-reforming reactor may include, but is not limited to, methane, methanol, ethane, ethanol, propane, and butane. Preferably, the temperature and pressure of the pre-reforming reactor are controlled to produce a feed containing at least 50 vol. %, or at least 60 vol. %, or at least 80 vol. % methane. In an embodiment, when the pre-reforming reactor 314 at least partially reforms the feed precursor, the feed fed from the pre-reforming reactor 314 to the reforming reactor 301 may contain hydrogen and carbon monoxide.

Upon formation of the feed in the pre-reforming reactor 314, the feed and the remaining steam may be fed from the pre-reforming reactor 314 to the reforming reactor 301 via line 309 at a temperature of from 350° C. to 650° C., where the feed and steam carry the heat from the pre-reforming reactor 314 into the reforming reactor 301. The mixture of feed and steam from the pre-reforming reactor 314 may be compressed with compressor 324 prior to being fed to the reforming reactor 301 so the pressure within the reforming reactor 301 is such that hydrogen produced in the reforming reactor 301 may be separated from the reforming reactor 301 through a high temperature hydrogen-separation membrane 303 located in the reforming reactor 301. The mixture of feed and steam may be compressed to a pressure of at least 0.5 MPa, or at least 1 MPa, or at least 2 MPa, or at least 3 MPa.

If necessary, additional steam may be fed into the reforming region 315 of the reforming reactor 301 from steam heated in heat exchanger 313. The additional steam may be fed from heat exchanger 313 to the reforming reactor 301 through line 311. Metering valve 310 may be used to regulate the amount of steam fed from heat exchanger 313 to the reforming reactor 301. Compressor 330 may be used to compress the steam to the pressure that the mixture of feed and steam are being fed to the reforming reactor 301.

The mixture of feed and steam from the pre-reforming reactor 314, and optionally additional steam from heat exchanger 313, may be fed into a reforming region 315 in the reforming reactor 301. The reforming region 315 may, and preferably does, contain a reforming catalyst therein. The reforming catalyst may be a conventional steam reforming catalyst, and may be any known in the art. Typical steam reforming catalysts which can be used include, but are not limited to, Group VIII transition metals, particularly nickel. It is often desirable to support the reforming catalysts on a refractory substrate (or support). The support, if used, is preferably an inert compound. Suitable inert compounds for use as a support contain elements of Group III and IV of the Periodic Table, such as, for example the oxides or carbides of Al, Si, Ti, Mg, Ce and Zr.

The feed and steam are mixed and contacted with the reforming catalyst in the reforming region 315 at a temperature effective to form a reformed product gas containing hydrogen and carbon oxides. The reformed product gas may be formed by steam reforming the hydrocarbons in the feed. The reformed product gas may also be formed by shift reacting carbon monoxide in the feed and/or produced by steam reforming with additional steam. The reformed product gas may contain hydrogen and at least one carbon oxide. Carbon oxides that may be in the reformed product gas include carbon monoxide and carbon dioxide.

One or more high temperature tubular hydrogen-separation membranes 303 may be located in the reforming region 315 of the reforming reactor 301 positioned so the reformed product gas may contact the hydrogen-separation membrane(s) 303 and hydrogen may pass through the membrane wall member 323 to a hydrogen conduit 325 located within the tubular membrane 303. The membrane wall member 323 separates the hydrogen conduit 325 from gaseous communication with non-hydrogen compounds of reformed product gas, feed, and steam in the reforming region 315, and is selectively permeable to hydrogen, elemental and/or molecular, so that hydrogen in the reformed product gas may pass through the membrane wall member 323 to the hydrogen conduit 325 while other gases in the reforming region are prevented by the membrane wall member 323 from passing to the hydrogen conduit 325.

The high temperature tubular hydrogen-separation membrane(s) 303 in the reforming region may comprise a support coated with a thin layer of a metal or alloy that is selectively permeable to hydrogen. The support may be formed of a ceramic or metallic material that is porous to hydrogen. Porous stainless steel or porous alumina are preferred materials for the support of the membrane 303. The hydrogen selective metal or alloy coated on the support may be selected from metals of Group VIII, including, but not limited to Pd, Pt, Ni, Ag, Ta, V, Y, Nb, Ce, In, Ho, La, Au, and Ru, particularly in the form of alloys. Palladium and platinum alloys are preferred. A particularly preferred membrane 303 used in the present process has a very thin film of a palladium alloy having a high surface area coating a porous stainless steel support. Membranes of this type can be prepared using the methods disclosed in U.S. Pat. No. 6,152,987. Thin films of platinum or platinum alloys having a high surface area would also be suitable as the hydrogen selective material.

The pressure within the reforming region 315 of the reforming reactor 301 is maintained at a level significantly above the pressure within the hydrogen conduit 325 of the tubular membrane 303 so that hydrogen is forced through the membrane wall member 323 from the reforming region 315 of the reforming reactor into the hydrogen conduit 125. In an embodiment, the hydrogen conduit 325 is maintained at or near atmospheric pressure, and the reforming region is maintained at a pressure of at least 0.5 MPa, or at least 1.0 MPa, or at least 2 MPa, or at least 3 MPa. As noted above, the reforming region 315 may be maintained at such elevated pressures by compressing the mixture of steam and feed from the pre-reforming reactor with compressor 324 and injecting the mixture of feed and steam at high pressures into the reforming region 315. Alternatively, the reforming region 315 may be maintained at such high pressures by compressing additional steam from heat exchanger 313 with compressor 330 and injecting the high pressure steam into the reforming region 315 of the reforming reactor 301. The reforming region 315 of the reforming reactor 301 may be maintained at a pressure of at least 0.5 MPa, or at least 1.0 MPa, or at least 2.0 MPa, or at least 3.0 MPa.

The temperature at which the feed and steam are mixed and contacted with the reforming catalyst in the reforming region 315 of the reforming reactor 301 is at least 400° C., and preferably may range from 400° C. to 650° C., most preferably in a range of from 450° C. to 550° C. As noted above, unlike typical steam reforming reactions, which produce hydrogen at temperatures in excess of 750° C., the equilibrium of the reforming reaction of the present process is driven towards the production of hydrogen in the reforming reactor 301 operating temperature range of 400° C. to 650° C. since hydrogen is removed from the reforming region 315 into the hydrogen conduit 325 of the hydrogen separation membrane(s) 303. An operating temperature of 400° C. to 650° C. favors the shift reaction as well, converting carbon monoxide and steam to more hydrogen, which is then removed from the reforming region 315 into the hydrogen conduit 325 of the hydrogen separation membrane(s) 303 through the membrane wall member 323 of the membrane(s) 303. The fuel cell 305 exhausts may be used to provide the required heat to induce the reforming and shift reactions in the reforming region 315 of the reforming reactor 301 through the exhaust conduits 317 and 319, as described in further detail below.

A non-hydrogen gaseous stream may be removed from the reforming region 315 via line 327, where the non-hydrogen gaseous stream may include unreacted feed and gaseous non-hydrogen reformed products in the reformed product gas. The non-hydrogen reformed products and unreacted feed may include carbon dioxide, water (as steam), and small amounts of carbon monoxide and unreacted hydrocarbons.

In an embodiment, the non-hydrogen gaseous stream separated from the reforming region 315 may be a carbon dioxide gas stream containing at least 0.9, or at least 0.95, or at least 0.98 mole fraction carbon dioxide on a dry basis. The carbon dioxide gas stream may be a high pressure gas stream, having a pressure of at least 1 MPa, or at least 2 MPa, or at least 2.5 MPa. The high pressure carbon dioxide gas stream may contain significant amounts of water as steam as it exits the reforming reactor 301. The water may be removed from the high pressure carbon dioxide gas stream by passing the stream through heat exchanger 313 via line 327 to exchange heat with the steam and feed precursor being fed to the pre-reforming reactor 314, cooling the high pressure carbon dioxide gas stream. The cooled high pressure carbon dioxide gas stream may be cooled further to condense the water from the stream in heat exchanger 329, where the cooled high pressure carbon dioxide stream may be passed to the heat exchanger 329 from heat exchanger 313 via line 331. The dry high pressure carbon dioxide stream may be removed from heat exchanger 329 via line 333. The condensed water may be fed to condenser 351 through line 355.

The dry high pressure carbon dioxide stream may be expanded through a turbine 335 to drive the turbine 335 and produce a low pressure carbon dioxide stream. The turbine 335 may be used to generate electricity in addition to electricity generated by the fuel cell 305. Alternatively, the turbine 335 may be used to drive one or more compressors, such as compressors 324, 330, and 361. The low pressure carbon dioxide stream may be sequestered or used for carbonation of beverages.

Alternatively, the high pressure carbon dioxide stream may not be converted to a low pressure carbon dioxide stream, and may be used for enhancing oil recovery from an oil formation by injecting the high pressure carbon dioxide stream into the oil formation.

A first gas stream containing hydrogen may be separated from the reformed product gas in the reforming reactor 301 by selectively passing hydrogen through the membrane wall member 323 of the hydrogen separation membrane(s) 303 into the hydrogen conduit 325 of the hydrogen separation membrane(s) 303. The first gas stream may contain a very high concentration of hydrogen, and may contain at least 0.6, or at least 0.7, or at least 0.8, or at least 0.9, or at least 0.95, or at least 0.98 mole fraction hydrogen.

A sweep gas comprising steam may be injected into the hydrogen conduit 325 via line 337 to sweep hydrogen from the inner portion of the membrane wall member 323, thereby increasing the rate hydrogen may be separated from the reforming region 315 by the hydrogen separation membrane 303. The first gas stream and steam sweep gas may be removed from the hydrogen separation membrane 303 and the reforming reactor 301 through hydrogen outlet line 339.

The first gas stream and the steam sweep gas may be fed to a heat exchanger 341 via hydrogen outlet line 339 to cool the first gas stream and steam sweep gas. The combined first gas stream and steam sweep gas may have a temperature of from 400° C. to 650° C., typically a temperature of from 450° C. to 550° C., upon exiting the reforming reactor 301. The combined first gas stream and steam sweep gas may exchange heat with the initial feed precursor and water/steam in the heat exchanger 341. The initial feed precursor may be provided to the heat exchanger 341 via line 343, and water/steam may be provided to the heat exchanger 341 via line 345, where the flow rate of the feed precursor and the water may be regulated by valves 342 and 344, respectively. The heated feed precursor and steam may fed to heat exchanger 313 via lines 347 and 349, respectively, for further heating prior to being fed to the pre-reforming reactor 314 as described above. The cooled combined first gas stream and steam sweep gas may be fed to condenser 351 through line 352 to condense water from the combined streams by exchanging heat with water fed into the condenser 351 via line 353 and condensed water separated from the high pressure carbon dioxide gas stream via line 355.

The water condensed in condenser 351 and water fed to the condenser 351 through lines 353 and 355 may be passed through water trap line 357 to a pump 359 which pumps the water to heat exchanger 329 for heat exchange with the cooled high pressure carbon dioxide gas stream to heat the water while further cooling the cooled high pressure carbon dioxide gas stream. The heated water/steam may be passed to the heat exchanger 341 via line 345, as described above, for further heating to produce steam to be fed to the pre-reforming reactor 314 after further heating in heat exchanger 313.

The cooled first gas stream containing hydrogen and little or no water may be fed from the condenser 351 to a compressor 361 through line 363. The first gas stream may have a pressure at or near atmospheric pressure upon exiting the reforming reactor and being fed through heat exchanger 341 and condenser 351 to the compressor 361. The first gas stream may be compressed in the compressor 361 to increase the pressure of the first gas stream prior to being fed to the fuel cell 305. In an embodiment, the first gas stream may be compressed to a pressure of from 0.15 MPa to 0.5 MPa, and preferably from 0.2 MPa to 0.3 MPa. Energy to drive the compressor 361 may be provided by expansion of the high pressure carbon dioxide stream through turbine 335 operatively coupled to drive the compressor 361.

The first gas stream may then be fed to the anode 307 of the solid oxide fuel cell 305 through line 367 into the anode inlet 365. The first gas stream provides hydrogen to the anode for electrochemical reaction with an oxidant at one or more anode electrodes along the anode path length in the fuel cell. The rate the first gas stream is fed to the anode 307 of the fuel cell 305 may be selected by selecting the rate that the feed and steam are fed to the reforming reactor 101, which in turn may be selected by the rate that the feed precursor and water are fed to the pre-reforming reactor 314, which may be controlled by adjusting metering valves 342 and 344 respectively.

A second gas stream containing hydrogen is also fed to the anode 307 of the fuel cell 305. The second gas stream may be separated from the anode exhaust stream, which contains hydrogen and water. The second gas stream may be separated from the anode exhaust stream by cooling the anode exhaust stream sufficiently to condense water from the anode gas exhaust stream to produce the second gas stream containing hydrogen.

The anode exhaust stream may be initially cooled by exchanging heat with steam and feed precursor in the pre-reforming reactor 314, and/or by exchanging heat with steam and a feed in the reforming reactor 301. The anode exhaust stream exits the anode 307 through the anode exhaust outlet 369.

In an embodiment, the anode exhaust stream may be fed through line 373 to one or more reformer anode exhaust conduits 319 extending into and located within the reforming region 315 of the reforming reactor 305. Heat may be exchanged between the anode exhaust stream and the feed and steam in the reforming region 315 of the reforming reactor 301 as the anode exhaust stream passes through the reforming region 315 in the reformer anode exhaust conduit 319, as described in further detail below, cooling the anode exhaust stream and heating the steam and feed in the reactor 301.

In an embodiment, the anode exhaust stream may be initially cooled by being fed through line 372 to one or more pre-reformer anode exhaust conduits 320 extending into and located within the pre-reforming region 316 of the pre-reforming reactor 314. Heat may be exchanged between the anode exhaust stream and a feed precursor and steam in the pre-reforming region 316 of the pre-reforming reactor 314 as the anode exhaust stream passes through the pre-reforming region 316 in the pre-reformer anode exhaust conduit 320, as described in further detail below, cooling the anode exhaust stream and heating steam and feed precursor in the pre-reforming reactor.

In an embodiment, the anode exhaust stream may be initially cooled by being fed to both the reforming reactor 301 and a pre-reforming reactor 314 through the reformer anode exhaust conduit 319 and through the pre-reformer anode exhaust conduit 320, respectively, as described above. A portion of the anode exhaust stream may be cooled in the reforming reactor 301 by exchanging heat with feed and steam in the reforming region 315 of the reforming reactor 301 as the anode exhaust passes through the reforming region 315 in the reformer anode exhaust conduit 319. The rest of the anode exhaust may be cooled in the pre-reforming reactor 314 by exchanging heat with the feed precursor and steam in the pre-reforming region 316 of the pre-reforming reactor 314 as the anode exhaust passes through the pre-reforming region in the pre-reformer anode exhaust conduit 320.

In another embodiment, the anode exhaust stream may be initially cooled by being fed first to the pre-reforming reactor 314, then being fed from the pre-reforming reactor to the reforming reactor 301. The anode exhaust stream may be fed from the anode exhaust outlet 369 to the pre-reformer anode exhaust conduit 320 to be cooled by exchanging heat with the feed precursor and steam in the pre-reforming region 316 of the pre-reforming reactor 314. The anode exhaust stream may then be fed from the pre-reformer anode exhaust conduit 320 to the reforming reactor 301 via line 374, where the anode exhaust stream may be fed to the reformer anode exhaust conduit 319 for further cooling by exchanging heat with feed and steam in the reforming region 315 of the reforming reactor 301 as the anode exhaust stream passes through the reformer anode exhaust conduit 319. Cooling the anode exhaust stream first by exchanging heat in the pre-reforming reactor 314 with the feed precursor and steam and subsequently by exchanging heat in the reforming reactor 301 with the feed and steam may be particularly effective for driving the respective pre-reforming and reforming reactions since the pre-reforming reaction requires more heat than the reforming reaction, and the reforming reaction may be run at a cooler temperature than the pre-reforming reaction to avoid heat damage to the high temperature hydrogen separation membrane 303 located in the reforming region 315 of the reforming reactor 301

Metering valves 370 and 371 may be used to control the amount of anode exhaust stream directed to the reforming reactor 301 and/or the pre-reforming reactor 314. The metering valves 370 and 371 may be adjusted to select the flow of the anode exhaust stream either to the reforming reactor 301 or to the pre-reforming reactor 314. Valve 368 may be used to control the flow of the anode exhaust stream from the pre-reformer anode exhaust conduit 320 to the reformer anode exhaust conduit 319 or from the pre-reformer anode exhaust conduit 320 to be combined with the cooled anode exhaust stream exiting the reformer anode exhaust conduit 319 as described below.

The cooled anode exhaust stream exits the reformer anode exhaust conduit 319 and/or the pre-reformer anode exhaust conduit 320 and may be cooled further to separate the second gas stream containing hydrogen from water in the anode exhaust stream. If any cooled anode exhaust stream exiting the pre-reforming reactor 314 is not passed to the reformer anode exhaust conduit 319 for further heat exchange in the reforming reactor 301, the cooled anode exhaust stream from the pre-reforming reactor 314 may be passed to heat exchanger 341 for further cooling through line 378. If any cooled anode exhaust stream exits the reforming reactor 301, the cooled anode exhaust stream may be passed to heat exchanger 341 through line 382 for further cooling. Cooled anode exhaust streams exiting both the reforming reactor 301 and the pre-reforming reactor 314 may be combined in line 382 and passed to heat exchanger 341 for further cooling.

In one embodiment, to control the flow rate of the second gas stream to the fuel cell 305, a portion of the anode exhaust stream may be passed to heat exchanger 341 via line 382 to further cool the selected portion of the anode exhaust stream by exchange of heat with the feed precursor from line 343 and steam from line 345, then fed to a condenser 375 via line 376 to further cool the selected portion of the anode exhaust stream. Hydrogen may be separated from the selected portion of the anode exhaust stream by condensing water from the anode exhaust stream in the condenser 375. The separated hydrogen may be fed to a hydrogen storage tank 377 through line 379. Water condensed from condenser 375 may be fed to pump 359 through line 380.

Cooled anode exhaust stream not fed to condenser 375 for separation into the hydrogen tank is used to provide the second gas stream to the fuel cell 305. The cooled anode exhaust stream may be passed to heat exchanger 341 via line 382 to further cool the anode exhaust stream by exchange of heat with the feed precursor from line 343 and steam from line 345, then mixed with the first gas stream and steam sweep gas by feeding the anode exhaust stream through line 381 to line 352. The mixture of anode exhaust stream, first gas stream, and steam sweep gas may be then fed to condenser 351 to further cool the anode exhaust stream. The second gas stream, derived from condensing water from the anode exhaust stream, may be separated from the condenser 351 via line 363 mixed together with the first gas stream. The second gas stream may contain at least 0.6, or at least 0.7, or at least 0.8, or at least 0.9, or at least 0.95, or at least 0.98 mole fraction hydrogen, where the hydrogen content of the second gas stream may be determined by determining the hydrogen content of the cooled anode exhaust stream on a dry basis. Water from the anode exhaust stream may be condensed in condenser 351 together with water from the first gas stream and the steam sweep gas, and removed from the condenser 351 through line 357 to be fed to pump 359.

Metering valves 383 and 385 may be used to select the rate of flow of the second gas stream to the solid oxide fuel cell 305. In order to block the flow of a second gas stream to the fuel cell and to store hydrogen in the hydrogen tank 377, valve 385 may be completely closed, blocking flow of the anode exhaust stream to the condenser 351 and the second gas stream to the solid oxide fuel cell while valve 383 may be completely opened to allow the anode exhaust stream to flow to condenser 375 and hydrogen to the hydrogen tank 377. Alternatively, valve 383 may be completely closed, blocking flow of the anode exhaust stream to condenser 375 and hydrogen to the hydrogen tank 377, and valve 385 may be completely opened to allow the entire anode exhaust stream to flow to the condenser 351 and the second gas stream to flow to the solid oxide fuel cell 305 at a maximum flow rate. The flow rate of the second gas stream to the solid oxide fuel cell may be selected by adjusting valves 383 and 385 in coordination to meter the flow rate of the anode exhaust stream to condenser 351 and the rate of the second gas stream to the solid oxide fuel cell 305. In a preferred embodiment, the flow rate of the second gas stream to the fuel cell 305 may be automatically controlled to a selected rate by automatically adjusting the metering valves 383 and 385 in response to the water and/or hydrogen content of the anode exhaust stream.

In an embodiment, when the first and second gas streams are combined by adjusting valves 383 and 385 as described above, a small portion of the combined first and second gas streams may be passed through a hydrogen separation device 387 as a bleed stream to remove any small amounts of carbon oxides that may be present in the combined first and second gas stream as a result of imperfect separation of hydrogen from carbon oxides by the hydrogen separation membrane 303 in the reforming reactor 301 when producing the first gas stream and its subsequent recycle in the second gas stream. Valves 389 and 391 may be utilized to control the flow of the bleed stream to the hydrogen separation device 387, where preferably valves 389 and 391 may permit a metered flow of the combined first and second gas streams simultaneously through lines 393 and 395, or, alternatively, separately through either line 393 or line 395. The hydrogen separation device 387 is preferably a pressure swing adsorption apparatus effective for separating hydrogen from carbon oxides, or may be a membrane selectively permeable to hydrogen such as those described above. The first and second gas streams in lines 395 and 397 may be combined to be fed to the solid oxide fuel cell 305 through line 367.

In an embodiment of the process, the temperature of the first gas stream or the combined first and second gas streams and pressure of the first gas stream or the combined first and second gas streams may be selected for effective operation of the solid oxide fuel cell 305. In particular, the temperature should not be so low as to inhibit the electrochemical reactivity of the fuel cell and should not be so high as to induce an uncontrolled exothermic reaction in the fuel cell 305. In an embodiment, the temperature of the first gas stream or the combined first and second gas streams may range from 25° C. to 300° C., or from 50° C. to 200° C., or from 75° C. to 150° C. The pressure of the first gas stream or the combined first and second streams may be controlled by the compression provided to the combined first and second gas streams by compressor 361, and may be from 0.15 MPa to 0.5 MPa, or from 0.2 MPa to 0.3 MPa.

An oxygen containing gas stream may be fed to the cathode 399 of the fuel cell through cathode inlet 401 via line 403. The oxygen containing gas stream may be provided by an air compressor or an oxygen tank (not shown). In an embodiment, the oxygen containing gas stream may be air or pure oxygen. In another embodiment, the oxygen containing gas stream may be an oxygen enriched air stream containing at least 21% oxygen, where the oxygen enriched air stream provides higher electrical efficiency in the solid oxide fuel cell than air since the oxygen enriched air stream contains more oxygen for conversion into ionic oxygen in the fuel cell.

The oxygen containing gas stream may be heated prior to being fed to the cathode 399 of the fuel cell 305. In one embodiment, the oxygen containing gas stream may be heated to a temperature of from 150° C. to 350° C. prior to being fed to the cathode 399 of the fuel cell 305 in heat exchanger 405 by exchanging heat with a portion of the cathode exhaust provided to the heat exchanger from the cathode exhaust outlet 407 via line 409. The flow rate of the cathode exhaust stream to the heat exchanger 405 may be controlled with metering valve 411. Alternatively, the oxygen containing gas stream may be heated by an electrical heater (not shown), or the oxygen containing gas stream may be provided to the cathode 399 of the fuel cell 305 without heating.

The solid oxide fuel cell 305 used in this embodiment of the process of the invention may be a conventional solid oxide fuel cell, preferably having a planar or tubular configuration, and is comprised of an anode 307, a cathode 399, and an electrolyte 413 where the electrolyte 413 is interposed between the anode 307 and the cathode 399. The solid oxide fuel cell may be comprised of a plurality of individual fuel cells stacked together-joined electrically by interconnects and operatively connected so that a fuel may flow through the anodes of the stacked fuel cells and an oxygen containing gas may flow through the cathodes of the stacked fuel cells. The solid oxide fuel cell 305 may be either a single solid oxide fuel cell or a plurality of operatively connected or stacked solid oxide fuel cells. In an embodiment, the anode 307 is formed of a Ni/ZrO₂ cermet, the cathode 399 is formed of a doped lanthanum manganite or stabilized ZrO₂ impregnated with praseodymium oxide and covered with SnO doped In₂O₃, and the electrolyte 413 is formed of yttria stabilized ZrO₂ (approximately 8 mol % Y₂O₃). The interconnect between stacked individual fuel cells or tubular fuel cells may be a doped lanthanum chromite.

The solid oxide fuel cell 305 is configured so that the first gas stream or the combined first and second gas streams may flow through the anode 307 of the fuel cell 305 from the anode inlet 365 to the anode exhaust outlet 369, contacting one or more anode electrodes over the anode path length from the anode inlet 365 to the anode exhaust outlet 369. The fuel cell 305 is also configured so that the oxygen containing gas may flow through the cathode 399 from the cathode inlet 401 to the cathode exhaust outlet 407, contacting one or more cathode electrodes over the cathode path length from the cathode inlet 401 to the cathode exhaust outlet 407. The electrolyte 413 is positioned in the fuel cell 305 to prevent the first and second gas streams from entering the cathode and to prevent the oxygen containing gas from entering the anode, and to conduct ionic oxygen from the cathode to the anode for electrochemical reaction with hydrogen in the first gas stream or the combined first and second gas streams at the one or more anode electrodes.

The solid oxide fuel cell 305 is operated at a temperature effective to enable ionic oxygen to traverse the electrolyte 413 from the cathode 399 to the anode 307 of the fuel cell 305. The solid oxide fuel cell 305 may be operated at a temperature of from 700° C. to 1100° C., or from 800° C. to 1000° C. The oxidation of hydrogen with ionic oxygen at the one or more anode electrodes is a very exothermic reaction, and the heat of reaction generates the heat required to operate the solid oxide fuel cell 305. The temperature at which the solid oxide fuel cell is operated may be controlled by independently controlling the temperature of the first gas stream, the temperature of the second gas stream fed to the fuel cell (if any), and the oxygen containing gas stream, and the flow rates of these streams to the fuel cell 305. In an embodiment, the temperature of the second gas stream fed to the fuel cell is controlled to a temperature of at most 100° C., the temperature of the oxygen containing gas stream is controlled to a temperature of at most 300° C., and the temperature of the first gas stream is controlled to a temperature of at most 550° C. to maintain the operating temperature of the solid oxide fuel cell in a range from 700° C. to 1000° C., and preferably in a range of from 800° C. to 900° C.

To initiate operation of the fuel cell 305, the fuel cell 305 is heated to its operating temperature. In a preferred embodiment, operation of the solid oxide fuel cell 305 may be initiated by generating a hydrogen containing gas stream in a catalytic partial oxidation reforming reactor 433 and feeding the hydrogen containing gas stream through line 435 to the anode 307 of the solid oxide fuel cell. A hydrogen containing gas stream may be generated in the catalytic partial oxidation reforming reactor 433 by combusting a hydrocarbon feed and an oxygen source in the catalytic partial oxidation reforming reactor 433 in the presence of a conventional partial oxidation reforming catalyst, where the oxygen source is fed to the catalytic partial oxidation reforming reactor 433 in a substoichiometric amount relative to the hydrocarbon feed.

The hydrocarbon feed fed to the catalytic partial oxidation reforming reactor 433 may be a liquid or gaseous hydrocarbon or mixtures of hydrocarbons, and preferably is methane, natural gas, or other low molecular weight hydrocarbon or mixture of low molecular weight hydrocarbons. In a particularly preferred embodiment of the process of the invention, the hydrocarbon feed fed to the catalytic partial oxidation reforming reactor 433 may a feed of the same type as the feed precursor used in the pre-reforming reactor 314 to reduce the number of hydrocarbon feeds required run the process.

The oxygen containing feed fed to the catalytic partial oxidation reforming reactor 433 may be pure oxygen, air, or oxygen enriched air. The oxygen containing feed should be fed to the catalytic partial oxidation reforming reactor 433 in substoichiometric amounts relative to the hydrocarbon feed to combust with the hydrocarbon feed in the catalytic partial oxidation reforming reactor 433.

The hydrogen containing gas stream formed by combustion of the hydrocarbon feed and the oxygen containing gas in the catalytic partial oxidation reforming reactor 433 contains compounds that may be oxidized in the anode 307 of the fuel cell 305 by contact with an oxidant at one or more of the anode electrodes, including hydrogen and carbon monoxide, as well as other compounds such as carbon dioxide. The hydrogen containing gas steam from the catalytic partial oxidation reforming reactor 433 preferably does not contain compounds that may oxidize the one or more anode electrodes in the anode 307 of the fuel cell 305.

The hydrogen containing gas stream formed in the catalytic partial oxidation reforming reactor 433 is hot, and may have a temperature of at least 700° C., or from 700° C. to 1100° C., or from 800° C. to 1000° C. Use of the hot hydrogen gas stream from a catalytic partial oxidation reforming reactor 433 to initiate start up of the solid oxide fuel cell 305 is preferred in the process of the invention since it enables the temperature of the fuel cell 305 to be raised to the operating temperature of the fuel cell 305 almost instantaneously. In an embodiment, heat may be exchanged in heat exchanger 405 between the hot hydrogen containing gas from the catalytic partial oxidation reforming reactor 433 and an oxygen containing gas fed to the cathode 399 of the fuel cell 305 when initiating operation of the fuel cell 305.

Upon reaching the operating temperature of the fuel cell 305, the flow of the hot hydrogen containing gas stream from the catalytic partial oxidation reforming reactor 433 into the fuel cell 305 may be shut off by valve 439, while feeding the first gas stream from the reforming reactor 301 into the anode 307 by opening valve 441 and feeding the oxygen containing gas stream into the cathode 399 of the fuel cell 305. Continuous operation of the fuel cell may then conducted according to the process of the invention.

In another embodiment, operation of the fuel cell 305 may be initiated with a hydrogen start-up gas stream from a hydrogen storage tank (not shown) that may be passed through a start-up heater (not shown) to bring the fuel cell 305 up to its operating temperature prior to introducing the first gas stream into the fuel cell 305. The hydrogen storage tank may be operatively connected to the fuel cell 305 to permit introduction of the hydrogen start-up gas stream into the anode 307 of the solid oxide fuel cell 305. The start-up heater may indirectly heat the hydrogen start-up gas stream to a temperature of from 750° C. to 1000° C. The start-up heater may be an electrical heater or may be a combustion heater. Upon reaching the operating temperature of the fuel cell 305, the flow of the hydrogen start-up gas stream into the fuel cell 305 may be shut off by a valve (not shown), and the first gas stream and the oxygen containing gas stream may be introduced into the fuel cell 305 to start the operation of the fuel cell.

During initiation of operation of the fuel cell 305, a oxygen containing gas stream may be introduced into the cathode 399 of the fuel cell 305. The oxygen containing gas stream may be air, oxygen enriched air containing at least 21% oxygen, or pure oxygen. Preferably, the oxygen containing gas stream may be the oxygen containing gas stream that will be fed to the cathode 399 during operation of the fuel cell 305 during operation of the fuel cell 305 after initiating operation of the fuel cell.

In a preferred embodiment, the oxygen containing gas stream fed to the cathode 399 of the fuel cell during start-up of the fuel cell has a temperature of at least 500° C., more preferably at least 650° C., and more preferably at least 750° C. The oxygen containing gas stream may be heated by an electric heater before being fed to the cathode 399 of the solid oxide fuel cell 305. In a preferred embodiment, the oxygen containing gas stream used in initiating operation of the fuel cell 305 may be heated by heat exchange with a hot hydrogen containing gas stream from a catalytic partial oxidation reforming reaction in heat exchanger 405 prior to being fed to the cathode 399 of the fuel cell 305.

Once operation of the fuel cell has commenced, the first gas stream or the combined first and second gas streams may be mixed with an ionic oxygen oxidant at one or more anode electrodes in the fuel cell 305 to generate electricity. The ionic oxygen oxidant is derived from oxygen in the oxygen-containing gas stream flowing through the cathode 399 of the fuel cell 305 and conducted across the electrolyte 413 of the fuel cell. The first gas stream or the combined first and second gas streams fed to the anode 307 of the fuel cell 305 and the oxidant are mixed in the anode 307 at the one or more anode electrodes of the fuel cell 305 by feeding the first gas stream, the second gas stream (if any), and the oxygen containing gas stream to the fuel cell 305 at selected independent rates while operating the fuel cell at a temperature of from 750° C. to 1100° C.

The first gas stream or the combined first and second gas streams and the oxidant are preferably mixed at the one or more anode electrodes of the fuel cell 305 to generate electricity at an electrical power density of at least 0.4 W/cm², more preferably at least 0.5 W/cm², or at least 0.75 W/cm², or at least 1 W/cm², or at least 1.25 W/cm², or at least 1.5 W/cm². Electricity may be generated at such electrical power densities by selecting and controlling the rate that the first gas stream is fed to the anode 307 of the fuel cell 305 or independently selecting and controlling the flow rates of the first gas stream and the second gas stream to the anode 307 of the fuel cell 305. The flow rate of the first gas stream to the anode 307 of the fuel cell 305 may be selected and controlled by selecting and controlling the rate that the feed and steam are fed to the reforming reactor 301, which in turn is controlled by the rate that the feed precursor and steam are fed to the pre-reforming reactor 314, which is controlled by adjusting metering valves 342 and 344, respectively. The flow rate of the second gas stream to the anode 307 of the fuel cell 305 may be selected and controlled by selecting and controlling the flow rate of the anode exhaust stream to the condenser 351 by adjusting metering valves 383 and 385 as described above. In an embodiment, metering valves 383 and 385 may be automatically adjusted by a feedback circuit (not shown) that measures water and/or hydrogen content in the anode exhaust stream, and adjusts the metering valves 383 and 385 to maintain a selected water and/or hydrogen content in the anode exhaust stream.

In the process of the invention, mixing the first gas stream or the combined first and second gas streams and the oxidant at the one or more anode electrodes generates water (as steam) by the oxidation of a portion of hydrogen present in the first gas stream or the combined first and second gas streams fed to the fuel cell 305 with the oxidant. Water generated by the oxidation of hydrogen with an oxidant is swept through the anode 307 of the fuel cell 305 by the unreacted portion of the first gas stream or the combined first and second gas streams to exit the anode 307 as part of the anode exhaust stream.

In an embodiment of the process of the invention, the flow rate that the first gas stream is fed to the anode 307 and, if a second gas stream is provided to the anode 307, the flow rate that the second gas stream is fed to the anode 307 may be independently selected so the ratio of amount of water formed in the fuel cell 305 per unit of time to the amount of hydrogen in the anode exhaust per unit of time is at most 1.0, or at most 0.75, or at most 0.67, or at most 0.43, or at most 0.25, or at most 0.11. In an embodiment, the amount of water formed in the fuel cell 305 and the amount of hydrogen in the anode exhaust may be measured in moles so that the ratio of the amount of water formed in the fuel cell per unit of time to the amount of hydrogen in the anode exhaust per unit of time in moles per unit of time is at most 1.0, or at most 0.75, or at most 0.67, or at most 0.43, or at most 0.25, or at most 0.11. In another embodiment of the process of the invention, the flow rate that the first gas stream is fed to the anode 307 and, if a second gas stream is provided to the anode 307, the flow rate that the second gas stream is fed to the anode 307, may be independently selected so the anode exhaust stream contains at least 0.6, or at least 0.7, or at least 0.8, or at least 0.9 mole fraction hydrogen. In an embodiment, the flow rate that the first gas stream is fed to the anode 307 and, if a second gas stream is provided to the anode, the flow rate that the second gas stream is fed to the anode 307 may be independently selected so the anode exhaust stream contains at least 50%, or at least 60%, or at least 70%, or at least 80%, or at least 90% of the hydrogen in the combined first and second gas streams fed to the anode 307, or, if only the first gas stream is provided to the anode 307, the anode exhaust stream contains at least 50%, or at least 60%, or at least 70%, or at least 80%, or at least 90% of the hydrogen in the first gas stream provided to the anode 307. In an embodiment, the flow rate that the first gas stream is fed to the anode 307 and, if a second gas stream is provided to the anode, the flow rate that the second gas stream is fed to the anode 307 may be independently selected so the per pass hydrogen utilization rate in the fuel cell 305 is at most 50%, or at most 40%, or at most 30%, or at most 20%, or at most 10%.

The flow rate of the oxygen containing gas stream provided to the cathode 399 of the solid oxide fuel cell 305 should be selected to provide sufficient oxidant to the anode to generate electricity at an electrical power density of at least 0.4 W/cm², or at least 0.5 W/cm², or at least 0.75 W/cm², or at least 1 W/cm², or at least 1.25 W/cm², or at least 1.5 W/cm² when combined with the fuel from the first gas stream or the combined first and second gas streams at the one or more anode electrodes. The flow rate of the oxygen containing gas stream to the cathode 399 may be selected and controlled by adjusting metering valve 415.

In one embodiment of the process of the present invention, the reforming reactor 301 and the solid oxide fuel cell 305 may be thermally integrated so the heat from the exothermic electrochemical reaction in the fuel cell 305 is provided to the reforming region 315 of the reforming reactor 301 to drive the endothermic reforming reaction in the reforming reactor 301. As described above, one or more reformer anode exhaust conduits 319 and/or one or more reformer cathode exhaust conduits 317 extend into and are located within the reforming region 315 of the reforming reactor 301. A hot anode exhaust stream may exit the anode 307 of the fuel cell 305 from the anode exhaust outlet 369 and enter the reformer anode exhaust conduit 319 in the reforming region 315 via line 373, and/or a hot cathode exhaust stream may exit the cathode 399 of the fuel cell 305 from the cathode exhaust outlet 407 and enter the reformer cathode exhaust conduit 317 in the reforming region 315 via line 417. Heat from the hot anode exhaust stream may be exchanged between the anode exhaust stream and the mixture of steam and feed in the reforming region 315 as the anode exhaust stream passes through the reformer anode exhaust conduit 319. Likewise, heat from the hot cathode exhaust stream may be exchanged between the cathode exhaust stream and the mixture of steam and feed in the reforming region 315 of the reforming reactor 301 as the cathode exhaust stream passes through the reformer cathode exhaust conduit 317.

The heat exchange from the exothermic solid oxide fuel cell 305 to the endothermic reforming reactor 301 is highly efficient. Location of the reformer anode exhaust conduit(s) 319 and/or the reformer cathode exhaust conduit(s) 317 within the reforming region 315 of the reforming reactor 301 permits exchange of heat between the hot anode and cathode exhaust streams and the mixture of feed and steam within the reactor 301, transferring heat to the feed and steam at the location that the reforming reaction takes place. Further, location of the reformer anode and/or cathode exhaust conduits 319 and 317 within the reforming region 315 permits the hot anode and/or cathode exhaust streams to heat the reforming catalyst in the reforming region 315 as a result of the close proximity of the conduits 317 and 319 to the catalyst bed.

Further, no additional heat other than provided by the anode exhaust stream and/or the cathode exhaust stream needs to be provided to the reforming reactor 301 to drive the reforming and shift reactions in the reactor 301 to produce the reformed product gas and the first gas stream. As noted above, the temperature required to run the reforming and shift reactions within the reforming reactor 301 is from 400° C. to 650° C., which is much lower than conventional reforming reactor temperatures-which are at least 750° C., and typically 800° C.-900° C. The reforming reactor may be run at such low temperatures due to the equilibrium shift in the reforming reaction engendered by separation of hydrogen from the reforming reactor 301 by the high temperature hydrogen separation membrane 303. The anode exhaust stream and the cathode exhaust stream may have a temperature of from 800° C. to 1000° C., which, upon heat exchange between the anode exhaust stream and/or the cathode exhaust stream with the mixture of feed and steam, is sufficient to drive the lower temperature reforming and shift reactions in the reforming reactor 301.

In an embodiment of the process of the invention, the exchange of heat between the anode exhaust stream and the mixture of steam and feed in the reforming region 315 as the anode exhaust stream passes through the reformer anode exhaust conduit 319 may provide a significant amount of the heat provided to the mixture of steam and feed in the reactor 301 to drive the reforming and shift reactions. In an embodiment of the process of the invention, the exchange of heat between the anode exhaust stream and the mixture of steam and feed in the reactor 301 may provide at least 40%, or at least 50%, or at least 70%, or at least 90% of the heat provided to the mixture of steam and feed in the reactor 301. In an embodiment, the heat supplied to the mixture of steam and feed in the reforming reactor 301 consists essentially of the heat exchanged between the anode exhaust stream passing through the reformer anode exhaust conduit 319 and the mixture of steam and feed in the reforming reactor 301. In an embodiment of the process, the exchange of heat between the anode exhaust stream and the mixture of steam and feed in the reactor 301 may be controlled to maintain the temperature of the mixture of steam and feed in a range of from 400° C. to 650° C.

In an embodiment of the process of the invention, the exchange of heat between the cathode exhaust stream and the mixture of steam and feed in the reforming region 315 as the cathode exhaust stream passes through the reformer cathode exhaust conduit 317 may provide a significant amount of the heat provided to the mixture of steam and feed in the reactor 301 to drive the reforming and shift reactions. In an embodiment of the process of the invention, the exchange of heat between the cathode exhaust stream and the mixture of steam and feed in the reactor 301 may provide at least 40%, or at least 50%, or at least 70%, or at least 90% of the heat provided to the mixture of steam and feed in the reactor 301. In an embodiment, the heat supplied to the mixture of steam and feed in the reforming reactor 301 consists essentially of the heat exchanged between the cathode exhaust stream passing through the reformer cathode exhaust conduit 317 and the mixture of steam and feed in the reforming reactor 301. In an embodiment of the process, the exchange of heat between the cathode exhaust stream and the mixture of steam and feed in the reactor 301 may be controlled to maintain the temperature of the mixture of steam and feed in a range of from 400° C. to 650° C.

In an embodiment, the exchange of heat between the anode exhaust stream, the cathode exhaust stream, and the mixture of steam and feed in the reforming region 315 as the anode exhaust stream passes through the reformer anode exhaust conduit 319 and the cathode exhaust stream passes through the reformer cathode exhaust conduit 317 may provide a significant amount of the heat provided to the mixture of steam and feed in the reactor 301 to drive the reforming and shift reactions. In an embodiment of the process of the invention, the exchange of heat between the cathode exhaust stream and the mixture of steam and feed in the reactor 301 may provide up to 60%, or up to 50%, or up to 40%, or up to 30%, or up to 20% of the heat provided to the mixture of steam and feed in the reactor 301 while the exchange of heat between the anode exhaust stream and the mixture of steam and feed in the reactor 301 may provide at least 40%, or at least 50%, or at least 60%, or at least 70%, or at least 80% of the heat provided to the mixture of steam and feed in the reactor 301. In an embodiment, the heat supplied to the mixture of steam and feed in the reforming reactor 301 may consist essentially of heat exchanged between the anode and cathode exhaust streams and the mixture of steam and feed in the reactor 301. In an embodiment of the process, the exchange of heat between the anode and cathode exhaust streams and the mixture of steam and feed in the reactor 301 may be controlled to maintain the temperature of the mixture of steam and feed in a range of from 400° C. to 650° C.

In a preferred embodiment, the heat provided by the anode exhaust stream or the cathode exhaust stream or the anode and cathode exhaust streams to the mixture of steam and feed in the reforming reactor 301 is sufficient to drive the reforming and shift reactions in the reforming reactor 301 such that no other source of heat is required to drive the reactions in the reforming reactor 301. Most preferably, no heat is provided to the mixture of steam and feed in the reforming reactor 301 by electrical heating or combustion.

In an embodiment, the anode exhaust stream provides most, or all, of the heat to the mixture of steam and feed in the reforming reactor 301 to drive the reforming and shift reactions in the reactor. Metering valves 371 and 370 may be adjusted to control the flow of the anode exhaust stream from the fuel cell to the reformer anode exhaust conduit 319, where the flow of the anode exhaust stream through the valve 371 may be increased and its flow through valve 370 may be decreased to increase flow of the anode exhaust stream into the reformer anode exhaust conduit 319 to provide the heat required to drive the reforming and shift reactions in reforming reactor 301.

In this embodiment only some, or none, of the cathode exhaust stream is required to exchange heat with the mixture of steam and feed in the reforming reactor 301 to drive the reforming and shift reactions. The flow of the cathode exhaust stream through the reforming cathode exhaust conduit 317 in the reforming reactor 301 may be controlled to control the amount of heat provided to the mixture of steam and feed in the reforming reactor 301 from the cathode exhaust stream. Metering valves 411, 412, 429, and 431 may be adjusted to control the flow of the cathode exhaust stream to the reformer cathode exhaust conduit 317 such that the cathode exhaust stream provides the desired amount of heat, if any, to the mixture of steam and feed in the reactor 301. To decrease the flow of cathode exhaust to the reforming reactor 301 through the reformer cathode exhaust conduit 317, valves 412 and 431 may be adjusted to decrease flow of the cathode exhaust through valves 412 and 431 and valves 411 and 429 may be adjusted to increase flow of the cathode exhaust through valves 411 and 429.

In an embodiment, the cathode exhaust stream provides most, or all, of the heat to the mixture of steam and feed in the reforming reactor 301 to drive the reforming and shift reactions in the reactor. Metering valves 411, 412, 429, and 431 may be adjusted to control the flow of the cathode exhaust stream to the reformer cathode exhaust conduit 317 such that the cathode exhaust stream provides the desired amount of heat to the mixture of steam and feed in the reactor 301. To increase the flow of cathode exhaust to the reforming reactor 301 through the reformer cathode exhaust conduit 317, valves 412 and 431 may be adjusted to increase flow of the cathode exhaust through valves 412 and 431 and valves 411 and 429 may be adjusted to decrease flow of the cathode exhaust through valves 411 and 429.

In this embodiment only some, or none, of the anode exhaust stream is required to exchange heat with the mixture of steam and feed in the reforming reactor 301 to drive the reforming and shift reactions. The flow of the anode exhaust stream through the reforming anode exhaust conduit 319 in the reforming reactor 301 may be controlled to control the amount of heat provided to the mixture of steam and feed in the reforming reactor 301 from the anode exhaust stream. Metering valves 371 and 370 may be adjusted to control the flow of the anode exhaust stream from the fuel cell 305 to the reformer anode exhaust conduit 319, where anode exhaust stream flow through the valve 371 may be decreased and its flow through the valve 370 may be increased to decrease flow of the anode exhaust stream into the reformer anode exhaust conduit 319.

The cooled cathode exhaust stream that has passed through the reformer cathode exhaust conduit 317 may still have a significant amount of heat therein, and may have a temperature of up to 650° C. The cooled cathode exhaust stream may be passed out of the cathode exhaust conduit through outlet 418 to be fed to the oxygen containing gas heat exchanger 405 through line 419 along with any cathode exhaust stream metered to the heat exchanger 405 through valve 411. The cooled anode exhaust stream that has passed through the reformer anode exhaust conduit 319 is treated as described above to provide the second gas stream to the fuel cell 305.

In one embodiment of the process of the present invention, the pre-reforming reactor 314 and the solid oxide fuel cell 305 may be thermally integrated so the heat from the exothermic electrochemical reaction in the fuel cell 305 is provided to the pre-reforming region 316 of the pre-reforming reactor 314 to drive the endothermic vaporization and cracking/reforming reactions in the pre-reforming reactor 314. As described above, one or more pre-reformer anode exhaust conduits 320 and/or one or more pre-reformer cathode exhaust conduits 322 extend into and are located within the pre-reforming region 316 of the pre-reforming reactor 314. A hot anode exhaust stream may exit the anode 307 of the fuel cell 305 from the anode exhaust outlet 369 and enter the pre-reformer anode exhaust conduit 320 in the pre-reforming region 316 via line 372, and a hot cathode exhaust stream may exit the cathode 399 of the fuel cell 305 from the cathode exhaust outlet 407 and enter the pre-reformer cathode exhaust conduit 322 in the pre-reforming region 316 via line 421. Heat from the hot anode exhaust stream may be exchanged between the anode exhaust stream and the mixture of steam and feed precursor in the pre-reforming region 316 as the anode exhaust stream passes through the pre-reformer anode exhaust conduit 320. Likewise, heat from the hot cathode exhaust stream may be exchanged between the cathode exhaust stream and the mixture of steam and feed precursor in the pre-reforming region 316 of the pre-reforming reactor 314 as the cathode exhaust stream passes through the pre-reformer cathode exhaust conduit 322.

The heat exchange from the exothermic solid oxide fuel cell 305 to the endothermic pre-reforming reactor 314 is highly efficient. Location of the pre-reformer anode exhaust conduit(s) 320 and/or the pre-reformer cathode exhaust conduit(s) 322 within the pre-reforming region 316 of the pre-reforming reactor 314 permits exchange of heat between the hot anode and/or cathode exhaust streams and the mixture of feed precursor and steam within the reactor 314, transferring heat to the feed precursor and steam at the location that the vaporization/cracking/reforming reactions take place. Further, location of the pre-reformer anode and/or cathode exhaust conduits 320 and 322 within the pre-reforming region 316 permits the hot anode and/or cathode exhaust streams to heat the pre-reforming catalyst in the pre-reforming region 316 as a result of the close proximity of the conduits 320 and 322 to the catalyst bed.

Further, no additional heat other than provided by the anode exhaust stream and/or the cathode exhaust stream needs to be provided to the pre-reforming reactor 314 to drive the vaporization/cracking/reforming reactions in the pre-reforming reactor 314 to produce the feed for the reforming reactor 301. The temperature required to crack or reform the feed precursor hydrocarbons to hydrocarbons useful as feed for the reforming reactor may be from 400° C. to 850° C., or from 500° C. to 800° C., and may be higher than required to reform the feed in the reforming reactor 301. The anode exhaust stream and the cathode exhaust stream may have a temperature of from 800° C. to 1000° C., which, upon heat exchange between the anode exhaust stream and/or the cathode exhaust stream and the mixture of feed precursor and steam, is sufficient to drive the conversion of feed precursors to feed in the pre-reforming reactor 314.

In an embodiment of the process of the invention, the exchange of heat between the anode exhaust stream and the mixture of steam and feed precursor in the pre-reforming region 316 as the anode exhaust stream passes through the pre-reformer anode exhaust conduit 320 may provide a significant amount of the heat provided to the mixture of steam and feed precursor in the pre-reforming reactor 314 to drive the pre-reforming/cracking reactions. In an embodiment of the process of the invention, the exchange of heat between the anode exhaust stream and the mixture of steam and feed precursor in the pre-reforming reactor 314 may provide at least 40%, or at least 50%, or at least 70%, or at least 90% of the heat provided to the mixture of steam and feed precursor in the pre-reforming reactor 314. In an embodiment, the heat supplied to the mixture of steam and feed precursor in the pre-reforming reactor 314 consists essentially of the heat exchanged between the anode exhaust stream passing through the pre-reformer anode exhaust conduit 320 and the mixture of steam and feed precursor in the pre-reforming reactor 314. In an embodiment of the process, the exchange of heat between the anode exhaust stream and the mixture of steam and feed in the pre-reforming reactor 314 may be controlled to maintain the temperature of the mixture of steam and feed precursor in a range of from 500° C. to 800° C.

In an embodiment of the process of the invention, the exchange of heat between the cathode exhaust stream and the mixture of steam and feed precursor in the pre-reforming region 316 as the cathode exhaust stream passes through the pre-reformer cathode exhaust conduit 322 may provide a significant amount of the heat provided to the mixture of steam and feed precursor in the pre-reforming reactor 314 to drive the vaporization/cracking/reforming reactions. In an embodiment of the process of the invention, the exchange of heat between the cathode exhaust stream and the mixture of steam and feed precursor in the pre-reforming reactor 314 may provide at least 40%, or at least 50%, or at least 70%, or at least 90% of the heat provided to the mixture of steam and feed precursor in the pre-reforming reactor 314. In an embodiment, the heat supplied to the mixture of steam and feed precursor in the pre-reforming reactor 314 consists essentially of the heat exchanged between the cathode exhaust stream passing through the pre-reformer anode exhaust conduit 322 and the mixture of steam and feed precursor in the pre-reforming reactor 314. In an embodiment of the process, the exchange of heat between the cathode exhaust stream and the mixture of steam and feed in the pre-reforming reactor 314 may be controlled to maintain the temperature of the mixture of steam and feed precursor in a range of from 500° C. to 800° C.

In an embodiment, the exchange of heat between the anode exhaust stream, the cathode exhaust stream, and the mixture of steam and feed precursor in the pre-reforming region 316 as the anode exhaust stream passes through the pre-reformer anode exhaust conduit 320 and the cathode exhaust stream passes through the pre-reformer cathode exhaust conduit 322 may provide a significant amount of the heat provided to the mixture of steam and feed precursor in the pre-reforming reactor 314 to drive the vaporization/cracking/reforming reactions. In an embodiment of the process of the invention, the exchange of heat between the cathode exhaust stream and the mixture of steam and feed precursor in the reactor 314 may provide up to 60%, or up to 50%, or up to 40%, or up to 30%, or up to 20% of the heat provided to the mixture of steam and feed precursor in the reactor 314 while the exchange of heat between the anode exhaust stream and the mixture of steam and feed precursor may provide at least 40%, or at least 50%, or at least 60%, or at least 70%, or at least 80% of the heat provided to the mixture of steam and feed precursor in the reactor 314. In an embodiment, the heat supplied to the mixture of steam and feed precursor in the pre-reforming reactor 314 may consist essentially of heat exchanged between the anode and cathode exhaust streams and the mixture of steam and feed precursor in the reactor 314. In an embodiment of the process, the exchange of heat between the anode and cathode exhaust streams and the mixture of steam and feed precursor in the reactor 314 may be controlled to maintain the temperature of the mixture of steam and feed precursor in a range of from 500° C. to 800° C.

In a preferred embodiment, the heat provided by the anode exhaust stream, or the cathode exhaust stream, or the anode and cathode exhaust streams to the mixture of steam and feed precursor in the pre-reforming reactor 314 is sufficient to drive the pre-reforming/cracking reactions in the reforming reactor 314 such that no other source of heat is required to drive the reactions in the pre-reforming reactor 314. Most preferably, no heat is provided to the mixture of steam and feed precursor in the reactor 314 by electric heat or combustion.

In an embodiment, the anode exhaust stream provides most, or all, of the heat to the mixture of steam and feed precursor in the pre-reforming reactor 314 to drive the vaporization/cracking/reforming reactions in the reactor 314. Metering valves 371 and 370 may be adjusted to control the flow of the anode exhaust stream from the fuel cell 305 to the pre-reformer anode exhaust conduit 320, where the flow of the anode exhaust stream through the valve 370 may be increased and its flow through valve 371 may be decreased to increase flow of the anode exhaust stream into the pre-reformer anode exhaust conduit 320 to provide the heat required to drive the vaporization/cracking/reforming reactions in pre-reforming reactor 314.

In this embodiment only some, or none, of the cathode exhaust stream is required to exchange heat with the mixture of steam and feed precursor in the pre-reforming reactor 314 to drive the vaporization/cracking/reforming reactions. The flow of the cathode exhaust stream through the pre-reforming cathode exhaust conduit 322 in the pre-reforming reactor 314 may be controlled to control the amount of heat provided to the mixture of steam and feed precursor in the pre-reforming reactor 314 from the cathode exhaust stream. Metering valves 411, 412, 429, and 431 may be adjusted to control the flow of the cathode exhaust stream to the pre-reformer cathode exhaust conduit 322 such that the cathode exhaust stream provides the desired amount of heat, if any, to the mixture of steam and feed precursor in the pre-reforming reactor 314. To decrease the flow of the cathode exhaust stream to the pre-reforming reactor 314 through the pre-reformer cathode exhaust conduit 322, valves 412 and 429 may be adjusted to decrease flow of the cathode exhaust through valves 412 and 429 and valves 411 and 431 may be adjusted to increase flow of the cathode exhaust through valves 411 and 431.

Cathode exhaust stream that is not required to heat the mixture of steam and feed in the reforming reactor 301 or pre-reforming reactor 314 may be shunted through line 409 to heat exchanger 405 to heat the oxygen containing gas fed to the cathode 399.

In an embodiment, the cathode exhaust stream provides most, or all, of the heat to the mixture of steam and feed precursor in the pre-reforming reactor 314 to drive the vaporization/cracking/reforming reactions in the reactor 314. Metering valves 411, 412, 429, and 431 may be adjusted to control the flow of the cathode exhaust stream to the pre-reformer cathode exhaust conduit 322 such that the cathode exhaust stream provides the desired amount of heat to the mixture of steam and feed precursor in the reactor 314. To increase the flow of the cathode exhaust stream to the pre-reforming reactor 314 through the pre-reformer cathode exhaust conduit 322, valves 412 and 429 may be adjusted to increase flow of the cathode exhaust stream through valves 412 and 429 and valves 411 and 431 may be adjusted to decrease flow of the cathode exhaust stream through valves 411 and 431.

In this embodiment only some, or none, of the anode exhaust stream is required to exchange heat with the mixture of steam and feed precursor in the pre-reforming reactor 314 to drive the vaporization/cracking/reforming reactions. The flow of the anode exhaust stream through the reforming anode exhaust conduit 320 in the pre-reforming reactor 314 may be controlled to control the amount of heat provided to the mixture of steam and feed precursor in the pre-reforming reactor 314 from the anode exhaust stream. Metering valves 371 and 370 may be adjusted to control the flow of the anode exhaust stream from the fuel cell 305 to the pre-reformer anode exhaust conduit 320, where anode exhaust stream flow through the valve 370 may be decreased and its flow through the valve 371 may be increased to decrease flow of the anode exhaust stream into the pre-reformer anode exhaust conduit 320.

The cooled cathode exhaust stream that has passed through the pre-reformer cathode exhaust conduit 322 may still have a significant amount of heat therein, and may have a temperature of up to 800° C. The cooled cathode exhaust stream may be passed out of the cathode exhaust conduit through outlet 423 to be fed to the oxygen containing gas heat exchanger 405 through line 419 along with any cathode exhaust stream metered to the heat exchanger 405 through valve 411.

In a preferred embodiment, the reforming reactor 301, the pre-reforming reactor 314, and the solid oxide fuel cell 305 may be thermally integrated so the heat from the exothermic electrochemical reaction in the fuel cell 305 is provided to both the reforming region 315 of the reforming reactor 301, to drive the endothermic reforming reaction in the reforming reactor 301, and the pre-reforming region 316 of the pre-reforming reactor 314 to drive the endothermic vaporization/cracking/reforming reactions. The fuel cell 305 may be operatively connected to the reforming reactor 301 and the pre-reforming reactor 314 as described above.

In an embodiment, the pre-reforming anode exhaust conduit(s) 320 may be operatively connected in series with the reforming anode exhaust conduit(s) 319 so that the anode exhaust stream may flow from the anode exhaust outlet 369 of the fuel cell 305 through the pre-reforming reactor 314, then through the reforming reactor 301. Flow of the anode exhaust stream from the pre-reformer anode exhaust conduit(s) 320 to the reformer anode exhaust conduit(s) 319 may be controlled by adjusting valve 368.

In an embodiment, the pre-reforming cathode exhaust conduit(s) 322 of the pre-reforming reactor 314 may be operatively connected in series with the reforming cathode exhaust conduit(s) 317 of the reforming reactor 301 so that the cathode exhaust stream may flow from the cathode exhaust outlet 407 through the pre-reforming reactor 314, then through line 425 into the reformer cathode exhaust conduit 317 of the reforming reactor 301. Flow of the cathode exhaust stream from the pre-reforming reactor 314 into the reforming reactor 301 through line 425 may be controlled by adjusting valve 427.

In another embodiment, the pre-reformer anode exhaust conduit(s) 320 and the reformer anode exhaust conduit(s) 319 may be operatively connected in parallel so the anode exhaust stream may flow from the anode exhaust outlet 365 simultaneously through both the pre-reformer anode exhaust conduit(s) 320 and the reformer anode exhaust conduit(s) 319. Metering valves 371 and 370 may be adjusted so that the anode exhaust stream flows into the reformer anode exhaust conduit(s) 319 and the pre-reformer anode exhaust conduit(s) 320, respectively, at desired rates.

In another embodiment, the pre-reformer cathode exhaust conduit(s) 322 may be operatively connected in parallel with the reformer cathode exhaust conduit(s) 317 so the cathode exhaust stream may flow from the cathode exhaust outlet 407 through the pre-reformer cathode exhaust conduit(s) 422 and the reformer cathode exhaust conduit(s) 417 simultaneously. Metering valves 431 and 429 may be adjusted so that the cathode exhaust stream flows into the reformer cathode exhaust conduit(s) 317 and the pre-reformer cathode exhaust conduit(s) 322, respectively, at desired rates.

The flow of the anode exhaust stream through the pre-reforming reactor 314 and the reforming reactor 301 to provide heat to the reactors 301 and 314 may be controlled by metering valves 370, 371, and 376. Metering valve 370 may be used to control the flow of the anode exhaust stream from the anode exhaust outlet 365 to the pre-reformer anode exhaust conduit(s) 320. Metering valve 371 may be used to control the flow of the anode exhaust stream from the anode exhaust outlet 365 to the reformer anode exhaust conduit(s) 319. Metering valve 376 may be used to control the flow of the anode exhaust stream from the pre-reformer anode exhaust conduit 320 so that the anode exhaust stream may be directed into the reformer anode exhaust conduit 319.

The flow of the cathode exhaust stream through the pre-reforming reactor 314 and the reforming reactor 301 to provide heat to the reactors 301 and 314 may be controlled by metering valves 412, 427, 429, and 431. Metering valve 412 may be used to control the flow of the cathode exhaust stream from the fuel cell cathode exhaust outlet to the pre-reforming reactor 314 and the reforming reactor 301. Metering valve 429 may be used to control the flow of the cathode exhaust stream from the cathode exhaust outlet 407 to the pre-reformer cathode exhaust conduit(s) 322. Metering valve 431 may be used to control the flow of the cathode exhaust stream from the cathode exhaust outlet 407 to the reformer cathode exhaust conduit(s) 317. Metering valve 427 may be used to control the flow of the cathode exhaust stream from the pre-reformer cathode exhaust conduit 322 so that the cathode exhaust stream may be directed into the reformer cathode exhaust conduit 317.

In this embodiment of the process of the present invention, relatively little carbon dioxide is generated per unit of electricity produced by the process. The thermal integration of the reforming reactor 301 and, optionally the pre-reforming reactor 314, with the fuel cell 305—wherein the heat produced in the fuel cell 305 is transferred within the reforming reactor 301, and optionally within the pre-reforming reactor 314 by the anode and/or cathode exhausts from the fuel cell 305—reduces the energy required to be provided to drive the endothermic reforming and pre-reforming reactions, reducing the need to provide such energy, for example by combustion, thereby reducing the amount of carbon dioxide produced in providing energy to drive the reforming reaction. Additionally, where the second gas stream is separated from the anode exhaust stream and recycled back to the fuel cell 305 as fuel, the hydrogen from the anode exhaust stream in the second gas stream to the fuel cell 305 reduces the amount of hydrogen required to be produced by the reforming reactor 301, thereby reducing attendant carbon dioxide by-product production.

In this embodiment of the process of the present invention, carbon dioxide is generated at a rate of no more than 400 grams per kilowatt-hour (400 g per kWh) of electricity generated. In a preferred embodiment, carbon dioxide is generated in the process of the present invention at a rate of no more than 350 g per kWh, and in a more preferred embodiment, carbon dioxide is generated in the process of the present invention at a rate of no more than 300 g per kWh.

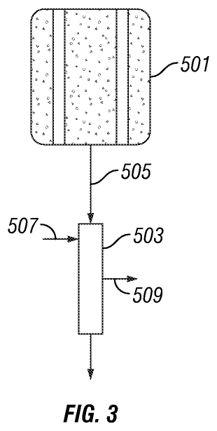

In another embodiment, the process of the present invention utilizes a system including a thermally integrated steam reformer, a hydrogen-separating device located exterior to the steam reformer, and a solid oxide fuel cell. Referring now to FIG. 3, the system for practicing the process of this embodiment is similar to that shown in FIG. 1 or in FIG. 2, except that the high temperature hydrogen-separation device 503 is not located in a reforming reactor 501, but is operatively coupled to the reforming reactor 501 so that a reformed product gas containing hydrogen and carbon oxides formed in the reforming reactor 501 and unreacted hydrocarbons and steam are passed through line 505 to the high temperature hydrogen-separation device 503. The high temperature hydrogen-separation device 503 is preferably a tubular hydrogen permeable membrane apparatus as described above.

A first gas stream containing hydrogen may be separated from the reformed product gas and unreacted steam and hydrocarbons by the hydrogen separation device 503. A steam sweep gas may be injected into the hydrogen separation device 503 through line 507 to facilitate separation of the first gas stream. The first gas stream may be fed from the hydrogen separation device to a heat exchanger, and subsequently to a condenser, and then to the solid oxide fuel cell as described above.

Gaseous non-hydrogen reformed products and unreacted feed may be separated as a gaseous stream from the hydrogen separation device 503 via line 509. The non-hydrogen reformed products and unreacted feed may include carbon dioxide, water (as steam), and small amounts of carbon monoxide and unreacted hydrocarbons.

The non-hydrogen gaseous stream separated from the hydrogen separation device 503 may be a high pressure carbon dioxide gas stream containing at least 0.9, or at least 0.95, or at least 0.98 mole fraction carbon dioxide on a dry basis, and having a pressure of at least 1 MPa, or at least 2 MPa, or at least 2.5 MPa. The high pressure carbon dioxide stream may be treated as described above with respect to the high pressure carbon dioxide stream separated from the reforming reactor with the hydrogen separation membrane located therein.

The remainder of the process utilizing the hydrogen separation device 503 located outside of the reforming reactor 501 may be practiced in the same manner as the process described above with respect to the solid oxide fuel cell and the reforming reactor containing the hydrogen separation membrane therein, with or without a pre-reforming reactor.

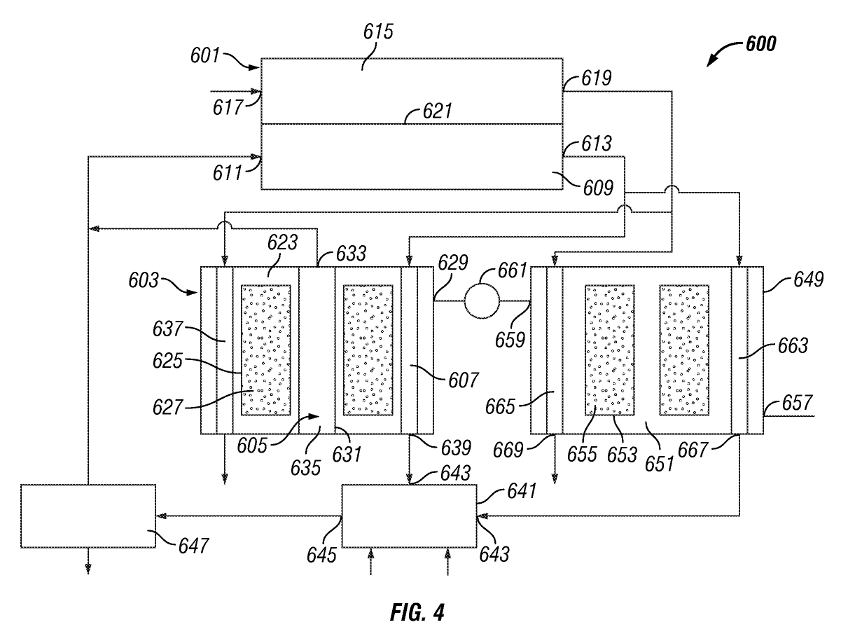

Referring now to FIG. 4, a system 600 in accordance with the present invention is shown. The system 600 includes a solid oxide fuel cell 601, a reforming reactor 603, a hydrogen separation apparatus 605, and an anode exhaust conduit 607 and/or a cathode exhaust conduit 637. The solid oxide fuel cell 601 comprises an anode 609 having an anode inlet 611 adapted to receive a hydrogen containing fuel gas and an anode exhaust outlet 613, a cathode 615 having a cathode inlet 617 adapted to receive an oxygen containing gas and a cathode exhaust outlet 619, and an electrolyte 621, where the electrolyte 621 is positioned between contacting and separating the anode 609 and the cathode 615. Solid oxide fuel cells useful in the system of the present invention, their anodes, cathodes, and electrolytes are described above.

The system 600 also includes a reforming reactor 603 that provides hydrogen fuel to the anode 609 of the fuel cell 601. The reforming reactor 603 includes a reforming region 623 that is adapted to reform a vaporized mixture of steam and a feed comprising one or more gaseous hydrocarbons to produce a reformed product gas containing hydrogen. The reforming region 623 may include a reforming catalyst bed 625 with a reforming catalyst 627 therein, where the reforming catalyst 627 may be positioned in the reforming catalyst bed 625 to contact a vaporized mixture of steam and feed in the reforming region 623 to assist in reforming the vaporized mixture of steam and feed in the reforming region 623 to produce the reformed product gas. Reforming catalysts 627 that may be used in the reforming catalyst bed 625 are described above. The reforming reactor 603 includes one or more reforming region inlets 629 coupled in gaseous communication with the reforming region 623 through which steam, a feed comprising one or more gaseous hydrocarbons, or a mixture of steam and a feed comprising one or more gaseous hydrocarbons may be introduced into the reforming region 623.

The system 600 further includes a hydrogen separation apparatus 605 for separating hydrogen produced in the reforming reactor 603, where the hydrogen separated by the hydrogen separation apparatus 605 is provided to the anode 609 of the fuel cell 601. The hydrogen separation apparatus 605 includes a member 631 that is selectively permeable to hydrogen, and a hydrogen gas outlet 633. In an embodiment, the member 631 that is selectively permeable to hydrogen is located in the reforming region 623 of the reforming reactor 603 in gaseous communication with the reforming region 623 so that hydrogen produced by reforming and/or water gas shift reactions in the reforming region 623 and/or present in the reforming region 623 may be separated from other gaseous compounds in the reforming region 623 through the member 631. In a preferred embodiment, the hydrogen separation apparatus 605 is a high-temperature hydrogen separation membrane, as described above, where the member 631 is the hydrogen-selective, hydrogen-permeable wall of the membrane.

The hydrogen gas outlet 633 of the hydrogen separation apparatus 605 is located in gaseous communication with the hydrogen permeable member 631 of the hydrogen separation apparatus 605, preferably through a hydrogen conduit 635. The hydrogen permeable member 631 is interposed between the reforming region 623 of the reforming reactor 603 and the hydrogen gas outlet 633 and the hydrogen conduit 635 to permit selective flow of hydrogen from the reforming region 623 through the hydrogen permeable member 631 to hydrogen conduit 635 and out of the hydrogen separation apparatus 605 and the reforming reactor 603 through the hydrogen gas outlet 633.

The hydrogen gas outlet 633 is operatively coupled in gaseous communication with an anode inlet 611 of the anode 609—through which hydrogen fuel may be fed to the anode 609—so that hydrogen produced in the reforming reactor 603 and separated therefrom by the hydrogen separation apparatus 605 may be fed to the anode 609 of the fuel cell 601. In an embodiment, one or more heat exchangers (not shown) may be coupled in gaseous communication between the hydrogen gas outlet 633 and the anode inlet 611 to cool the hydrogen gas stream exiting the hydrogen gas outlet 633 prior to the hydrogen gas stream entering the anode 609 of the fuel cell 601.

The system 600 may also include at least one anode exhaust conduit 607. At least a portion of each anode exhaust conduit 607 is located in the reforming region 623 of the reforming reactor 603 positioned within the reforming region 623 in thermal communication with the reforming region 623. Each anode exhaust conduit 607 is operatively coupled in gaseous communication with an anode exhaust outlet 613 of the anode 609 of the fuel cell 601 so that a hot gas exiting the anode 609 of the fuel cell 601 through the anode exhaust outlet 613 may be communicated to the anode exhaust conduit 607 in the reforming region 623 of the reforming reactor 603 to exchange heat with the catalyst 627 in the reforming region 623 and any steam or feed present in the reforming region 623.

The system 600 may also include at least one cathode exhaust conduit 637. At least a portion of each cathode exhaust conduit 637 is located in the reforming region 623 of the reforming reactor 603 positioned within the reforming region 623 in thermal communication with the reforming region 623. Each cathode exhaust conduit 637 is operatively coupled in gaseous communication with a cathode exhaust outlet 619 of the cathode 615 of the fuel cell 601 so that a hot gas exiting the cathode 615 of the fuel cell 601 through the cathode exhaust outlet 619 may be communicated to the cathode exhaust conduit 637 in the reforming region 623 of the reforming reactor 603 to exchange heat with the catalyst 627 in the reforming region 623 and any steam or feed present in the reforming region 623.

The system 600 of the present invention includes either at least one anode exhaust conduit 609 as described above, or at least one cathode exhaust conduit 637 as described above, or both, located at least partially in the reforming region 623 of the reforming reactor 603 so that heat from the fuel cell 601 may be provided to the reforming region 623 of the reforming reactor 603 by passing an anode exhaust stream and/or a cathode exhaust stream from the fuel cell 601 through the anode exhaust conduit 609 and/or the cathode exhaust conduit 637, respectively.

In a preferred embodiment of the system 600, the anode exhaust conduit 607 may be operatively connected in gaseous communication with the anode inlet 611 of the anode 609 so that hydrogen in the anode exhaust may be recycled back into the anode 609 of the fuel cell 601. The anode exhaust conduit 607 may have an outlet 639 operatively coupled in gaseous communication with an anode inlet 611 through which an anode exhaust stream may exit the anode exhaust conduit 607 to be fed to the anode inlet 611.

The system 600 may include one or more heat exchanger(s) 641 to further cool the anode exhaust exiting the anode exhaust conduit 607 prior to feeding the anode exhaust back to the anode 609 through the anode inlet 611. The heat exchanger(s) 641 may cool the anode exhaust with any cooling medium, however, as described above, preferably the anode exhaust is cooled by exchanging heat with a feed or a feed precursor and/or steam that is to be used in the reforming reactor 603 to produce hydrogen to be fed to the fuel cell 601.

If the system 600 includes one or more heat exchangers 641, the heat exchanger(s) 641 are operatively coupled in the system 600 between the anode exhaust conduit 607 and the anode inlet 611 to cool the anode exhaust stream as the anode exhaust stream flows from the anode exhaust conduit 607 to the anode inlet 611. An inlet 643 of the heat exchanger 641 may be operatively connected in gaseous communication with the anode exhaust conduit outlet 639, and the outlet 645 of the heat exchanger 641 may be operatively connected in gaseous communication with the anode inlet 611. If one or more heat exchanger 641 is present in the system 600, the heat exchangers 641 may be arranged in series, where the heat exchanger inlet 643 of the first heat exchanger 641 is operatively connected in gaseous communication with the anode exhaust conduit outlet 639 and the heat exchanger outlet 645 of the last of the heat exchangers 641 is operatively connected in gaseous communication with the anode inlet 611 of the anode 609 of the fuel cell 601, where the heat exchanger outlet 645 of each of the serially connected heat exchangers 641, except the final heat exchanger 641 of the series, may be connected in gaseous communication with the heat exchanger inlet 643 of the next heat exchanger 641 in the series.

In an embodiment, a condenser 647 may be operatively connected in gaseous communication between the heat exchanger outlet 645 or the anode exhaust conduit outlet 639 and the anode inlet 611 of the anode 609 of the fuel cell 601 to separate hydrogen from water/steam in the anode exhaust exiting the heat exchanger(s) 641 or the anode exhaust conduit 609 prior to feeding the hydrogen to the anode inlet 611. As noted above, when hydrogen is supplied as fuel to the fuel cell 601 the anode exhaust contains unreacted hydrogen and water produced by oxidation of hydrogen in the fuel cell 601. The cooled anode exhaust stream exiting the heat exchanger(s) 641 or the anode exhaust conduit 609 may be cooled in the condenser 647 sufficiently to condense and remove water from the cooled anode exhaust stream and thereby provide a high hydrogen content gas stream to the anode 609 of the fuel cell 601.

Optionally, the system 600 may include a pre-reforming reactor 649 for converting a feed precursor, such as those described above, to a feed useful in the reforming reactor 603. The pre-reforming reactor 649 may include a pre-reforming region 651 that is adapted to receive a liquid or vaporized mixture of steam and a feed precursor comprising one or more hydrocarbons to produce a feed to be provided to the reforming reactor 603. The pre-reforming reactor 649 may include a pre-reforming catalyst bed 653 with a pre-reforming catalyst 655 located therein positioned to contact a vapor in the pre-reforming region 651 of the pre-reforming reactor 649. Pre-reforming catalysts that may be used in the pre-reforming catalyst bed 653 are described above. The pre-reforming reactor 649 may include one or more pre-reforming stream inlets 657 coupled in gas/fluid communication with the pre-reforming region 651 and adapted to receive a feed precursor comprising one or more hydrocarbons, steam, or a mixture thereof and communicate the steam, feed precursor, or mixture thereof to the pre-reforming region 651. The pre-reforming reactor 649 may include an outlet 659 operatively coupled in gaseous communication with the reforming region inlet 629 of the reforming reactor 603 to supply feed formed in the pre-reforming reactor 649 to the reforming reactor 603. In one embodiment, a compressor 661 may be included in the system 600, where the compressor 661 is operatively connected in gaseous communication between the pre-reforming reactor outlet 659 and the reforming region inlet 625 so the compressor 661 may compress a feed produced by the pre-reforming reactor 649 prior to the feed being fed to the reforming reactor 603.

The system 600 including a pre-reforming reactor 649 may also include at least one pre-reformer anode exhaust conduit 663. At least a portion of each pre-reformer anode exhaust conduit 663 is located in the pre-reforming region 651 of the pre-reforming reactor 649 positioned within the pre-reforming region 651 in thermal communication with the pre-reforming region 651. Each pre-reformer anode exhaust conduit 665 may be operatively coupled in gaseous communication with an anode exhaust outlet 613 of the anode 609 of the fuel cell 601 so that a hot gas exiting the anode 609 of the fuel cell 601 through an anode exhaust outlet 613 may be communicated to the pre-reformer anode exhaust conduit 665 in the pre-reforming region 651 of the pre-reforming reactor 649 to exchange heat with the pre-reforming catalyst 655 in the pre-reforming region 651 and any steam or feed precursor present in the pre-reforming region 651.

The system 600 including a pre-reforming reactor 649 may also include at least one pre-reformer cathode exhaust conduit 665. At least a portion of each pre-reformer cathode exhaust conduit 665 is located in the pre-reforming region 651 of the pre-reforming reactor 649 positioned within the pre-reforming region 651 in thermal communication with the pre-reforming region 651. Each pre-reformer cathode exhaust conduit 665 is operatively coupled in gaseous communication with a cathode exhaust outlet 619 of the cathode 615 of the fuel cell 601 so that a hot gas exiting the cathode 615 of the fuel cell 601 through a cathode exhaust outlet 619 may be communicated to the pre-reformer cathode exhaust conduit 665 in the pre-reforming region 651 of the pre-reforming reactor 649 to exchange heat with the pre-reformer catalyst 655 in the pre-reforming region 651 and any steam or feed precursor present in the pre-reforming region 651.

In a system 600 including a pre-reforming reactor 649 and at least one pre-reformer anode exhaust conduit 663 and at least one anode exhaust conduit 607, the outlet 667 of the pre-reformer anode exhaust conduit 663 may be operatively connected to the anode exhaust conduit 607 so that an anode exhaust stream may be fed from the pre-reformer anode exhaust conduit 663 to the anode exhaust conduit 607. In a system 600 including a pre-reforming reactor 649 and at least one pre-reformer cathode exhaust conduit 665 and at least one cathode exhaust conduit 637, the outlet 669 of the pre-reformer cathode exhaust conduit 665 may be operatively connected to the cathode exhaust conduit 637 so that a cathode exhaust stream may be fed from the pre-reformer cathode exhaust conduit 665 to the cathode exhaust conduit 637.

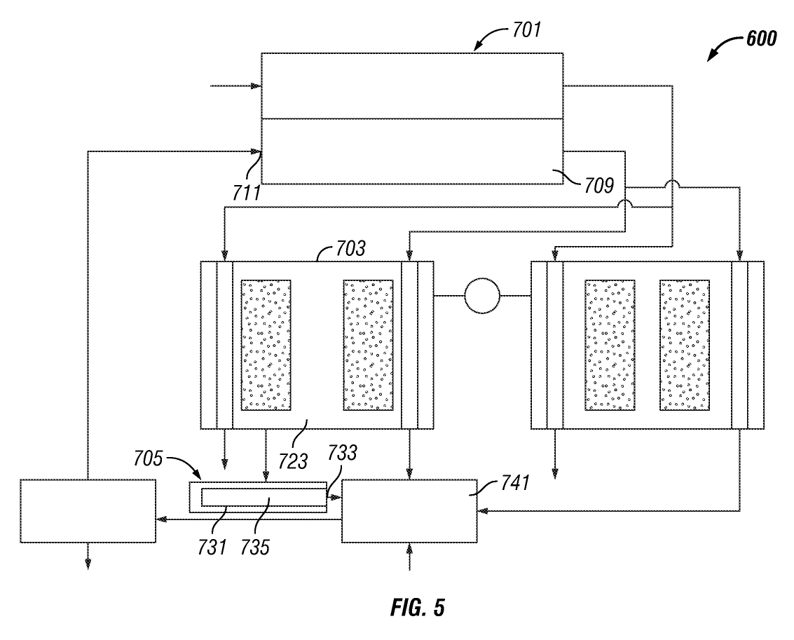

In another embodiment, as shown in FIG. 5, the hydrogen separation apparatus 705 may be located outside the reforming reactor 703. The hydrogen-permeable, hydrogen-selective member 731 may be operatively coupled in gaseous communication with the reforming region 723 of the reforming reactor 703 so the reformed gas products produced in the reforming region 723 may pass from the reforming region 723 to the member 731 so hydrogen may be separated from the reformed product gas by the member 731. In one embodiment, the member 731 may be a high-temperature hydrogen-permeable, hydrogen-selective membrane, as described above. In another embodiment, the member 731 may be a pressure swing adsorber. In an embodiment, particularly if the member 731 is a pressure swing adsorber, one or more heat exchangers (not shown) may be coupled in gaseous communication between the reforming region 723 of the reforming reactor 703 and the member 731 to cool the reformed product gas prior to separating hydrogen from the reformed product gas with the member 731.

The hydrogen gas outlet 733 of the hydrogen separation apparatus 705 is located in gaseous communication with the selectively hydrogen permeable member 731 of the hydrogen separation apparatus 705, preferably through a hydrogen conduit 735. The selectively hydrogen permeable member 731 is interposed between the reforming region 723 of the reforming reactor 703 and the hydrogen gas outlet 733 (and the hydrogen conduit 735) to permit selective flow of hydrogen from the reforming region 723 through the hydrogen permeable member 731 to hydrogen conduit 735 and out of the hydrogen separation apparatus 705 through hydrogen gas outlet 733.

The hydrogen gas outlet 733 is operatively coupled in gaseous communication with the anode inlet 711 of the fuel cell 701 so that hydrogen produced in the reforming reactor 703 and separated from a reformed product gas by the hydrogen separation apparatus 705 may be fed to the anode 709 of the fuel cell 701. In an embodiment, one or more heat exchangers (not shown) may be coupled in gaseous communication between the hydrogen gas outlet 733 and the anode inlet 711 to cool the hydrogen gas stream exiting the hydrogen gas outlet 733 prior to the hydrogen gas stream entering the anode 709 of the fuel cell 701.

In an embodiment, the system of the present invention may be a system as depicted in FIG. 1 and described above in the description of a process of the present invention.

In an embodiment, the system of the present invention may be a system as depicted in FIG. 2 and described above in the description of a process of the present invention.

That which is claimed is:

1. A process for generating electricity, comprising:
in a reforming reactor, contacting a mixture of steam and a feed containing one or more gaseous hydrocarbons with a reforming catalyst at a temperature of at least about 400° C. to produce a reformed product gas containing hydrogen and at least one carbon oxide;
separating a first gas stream containing at least about 0.6 mole fraction hydrogen from the reformed product gas;
feeding the first gas stream to an anode of a solid oxide fuel cell;
mixing the first gas stream with an oxidant at one or more anode electrodes in the anode of the solid oxide fuel cell to generate electricity at an electrical power density of at least about 0.4 W/cm²;
separating an anode exhaust stream comprising hydrogen and water from the solid oxide fuel cell; and
within the reforming reactor, exchanging heat between the mixture of steam and feed and a heat source selected from the group consisting of the anode exhaust stream, a cathode exhaust stream separated from the fuel cell, and both the anode exhaust stream and the cathode exhaust stream.

2. The process of claim 1 wherein exchanging heat between the anode exhaust stream and the mixture of steam and feed in the reforming reactor provides at least about 40% of the heat provided to the mixture of steam and feed in the reforming reactor.

3. The process of claim 2 wherein exchanging heat between the cathode exhaust stream and the mixture of steam and feed in the reforming reactor provides up to about 60% of the heat provided to the mixture of steam and feed in the reforming reactor.

4. The process of claim 1 further comprising the step of controlling the heat exchange between the anode exhaust stream and the mixture of steam and feed in the reforming reactor to maintain the temperature of the mixture at a temperature of from about 400° C. to about 650° C., where the anode exhaust stream has a temperature of greater than at least about 750° C. prior to exchanging heat with the mixture of steam and feed.

5. The process of claim 4 further comprising the step of separating the first gas stream from the reformed product gas at a temperature within about 50° C. of the temperature of the mixture of steam and feed in the reforming reactor.

6. The process of claim 1 wherein exchanging heat between the cathode exhaust stream and the mixture of steam and feed in the reforming reactor provides at least about 40% of the heat provided to the mixture of steam and feed in the reforming reactor.

7. The process of claim 6 further comprising the step of controlling the heat exchange between the cathode exhaust stream and the mixture of steam and feed in the reforming reactor to maintain the temperature of the mixture at a temperature of from about 400° C. to about 650° C., where the cathode exhaust stream has a temperature of greater than at least about 750° C. prior to exchanging heat with the mixture of steam and feed.

8. The process of claim 7 further comprising the step of separating the first gas stream from the reformed product gas at a temperature within about 50° C. of the temperature of the mixture of steam and feed in the reforming reactor.

9. The process of claim 1 wherein heat supplied to the mixture of steam and feed in the reforming reactor consists essentially of the heat exchanged between the mixture of steam and feed and the anode and cathode exhaust streams.

10. The process of claim 9 further comprising the step of controlling the heat exchange between the mixture of steam and feed and the anode and cathode exhaust streams to maintain the temperature of the mixture of steam and feed at a temperature of from about 400° C. to about 650° C., where the anode and cathode exhaust streams each have a temperature, respectively, of at least about 750° C.

11. The process of claim 1 wherein the first gas stream is fed to the anode at a first rate where the first rate is selected so the anode exhaust stream contains at least about 0.6 mole fraction hydrogen.

12. The process of claim 1 wherein the first gas stream is fed to the anode at a first rate where the first rate is selected so the ratio of amount of water formed in the fuel cell to the amount of hydrogen in the anode exhaust is at most about 1.0.

13. The process of claim 1 further comprising the steps of:
separating hydrogen from the anode exhaust stream to form a second gas stream containing hydrogen; and
feeding the second gas stream to the anode of the solid oxide fuel cell; and
mixing the second gas stream with the oxidant at one or more anode electrodes in the anode of the solid oxide fuel cell to generate electricity.

14. The process of claim 13 wherein the first gas stream is fed to the anode at a first rate and the second gas stream is fed to the anode at a second rate where the first and second rates are selected so the anode exhaust stream contains at least about 0.6 mole fraction hydrogen.

15. The process of claim 13 wherein the first gas stream is fed to the anode at a first rate and the second gas stream is fed to the anode at a second rate where the first and second rates are selected so the ratio of amount of water formed in the fuel cell to the amount of hydrogen in the anode exhaust is at most about 1.0.

16. The process of claim 1 further comprising the steps of
separating a carbon dioxide gas stream containing at least about 0.9 mole fraction carbon dioxide and having a pressure of at least 2 MPa from the reformed product gas; and
expanding the carbon dioxide gas stream through a turbine.

17. A process for generating electricity, comprising:
in a pre-reforming reactor, contacting a mixture of steam and a feed precursor, the feed precursor containing a vaporizable hydrocarbon that is liquid at 20° C. at atmospheric pressure and that is vaporizable at temperatures up to 400° C. at atmospheric pressure, with a pre-reforming catalyst at a temperature of at least about 600° C. to produce a feed comprising one or more gaseous hydrocarbons;
in a reforming reactor, contacting a mixture of the feed and steam with a reforming catalyst at a temperature of at least about 400° C. to produce a reformed product gas containing hydrogen and at least one carbon oxide;
separating a first gas stream containing at least about 0.6 mole fraction hydrogen from the reformed product gas;
feeding the first gas stream to an anode of a solid oxide fuel cell;
mixing the first gas stream with an oxidant at one or more anode electrodes in the anode of the solid oxide fuel cell to generate electricity at an electrical power density of at least about 0.4 W/cm²; and
separating an anode exhaust stream comprising hydrogen and water from the solid oxide fuel cell; and
within the pre-reforming reactor, exchanging heat between the mixture of steam and feed precursor and a heat source selected from the group consisting of the anode exhaust stream, a cathode exhaust stream separated from the fuel cell, and both the anode exhaust stream and the cathode exhaust stream.

18. The process of claim 17 wherein exchanging heat between the anode exhaust stream and the mixture of steam and feed precursor in the pre-reforming reactor provides at least about 40% of the heat provided to the mixture of steam and feed precursor in the pre-reforming reactor.

19. The process of claim 17 further comprising the step of exchanging heat between at least a portion of the anode exhaust stream and the mixture of steam and feed within the reforming reactor.

20. The process of claim 17 further comprising the step of exchanging heat between the anode exhaust stream and the mixture of steam and feed within the reforming reactor after exchanging heat between the anode exhaust stream and the mixture of steam and feed precursor within the pre-reforming reactor.

21. The process of claim 17 wherein exchanging heat between the cathode exhaust stream and the mixture of steam and feed precursor in the pre-reforming reactor provides at least about 40% of the heat provided to the mixture of steam and feed precursor in the pre-reforming reactor.

22. The process of claim 17 further comprising the step of exchanging heat between at least a portion of the cathode exhaust stream and the mixture of steam and feed within the reforming reactor.

23. The process of claim 17 further comprising the step of exchanging heat between the cathode exhaust stream and the mixture of steam and feed within the reforming reactor after exchanging heat between the cathode exhaust stream and the mixture of steam and feed precursor within the pre-reforming reactor.

24. The process of claim 17 wherein heat supplied to the mixture of steam and feed precursor in the pre-reforming reactor consists essentially of the heat exchanged between the mixture of steam and feed precursor and the anode and cathode exhaust streams.

25. The process of claim 17 wherein heat supplied to the mixture of steam and feed in the reforming reactor consists essentially of heat exchange between the mixture of steam and feed precursor and a heat source selected from the group consisting of the anode exhaust stream, the cathode exhaust stream, and both the anode exhaust stream and the cathode exhaust stream.

26. The process of claim 17 wherein the first gas stream is fed to the anode at a first rate where the first rate is selected so the anode exhaust stream contains at least about 0.6 mole fraction hydrogen.

27. The process of claim 17 wherein the first gas stream is fed to the anode at a first rate where the first rate is selected so the ratio of amount of water formed in the fuel cell to the amount of hydrogen in the anode exhaust is at most about 1.0.

28. The process of claim 17 further comprising the steps of:
separating hydrogen from the anode exhaust stream to form a second gas stream containing hydrogen; and
feeding the second gas stream to the anode of the solid oxide fuel cell; and
mixing the second gas stream with the oxidant at one or more anode electrodes in the anode of the solid oxide fuel cell to generate electricity.

29. The process of claim 28 wherein the first gas stream is fed to the anode at a first rate and the second gas stream is fed to the anode at a second rate where the first and second rates are selected so the anode exhaust stream contains at least about 0.6 mole fraction hydrogen.

30. The process of claim 28 wherein the first gas stream is fed to the anode at a first rate and the second gas stream is fed to the anode at a second rate where the first and second rates are selected so the ratio of amount of water formed in the fuel cell to the amount of hydrogen in the anode exhaust is at most about 1.0.

31. The process of claim 17 further comprising the steps of
separating a carbon dioxide gas stream containing at least about 0.9 mole fraction carbon dioxide and having a pressure of at least 2 MPa from the reformed product gas; and
expanding the carbon dioxide gas stream through a turbine.
